(19) United States
(12) Patent Application Publication
(10) Pub. No.: US 2025/0358542 A1
(43) Pub. Date: Nov. 20, 2025

(54) IMAGE SENSOR AND IMAGE PROCESSING DEVICE INCLUDING THE SAME

(71) Applicant: SAMSUNG ELECTRONICS CO., LTD., Suwon-si (KR)

(72) Inventors: Deokha SHIN, Suwon-si (KR); Minwoong SEO, Suwon-si (KR)

(73) Assignee: SAMSUNG ELECTRONICS CO., LTD., Suwon-si (KR)

(21) Appl. No.: 19/016,735

(22) Filed: Jan. 10, 2025

(30) Foreign Application Priority Data
May 17, 2024 (KR) 10-2024-0064801

(51) Int. Cl. H04N 25/77; H04N 25/78

(52) U.S. Cl. CPC H04N 25/77; H04N 25/78

(57) ABSTRACT

An image sensor includes a pixel array including a plurality of pixels arranged in rows and columns. The plurality of pixels include a first pixel including a circuit that operates in a first shutter mode and a circuit that operates in a second shutter mode, and a second pixel including a circuit that operates only in the first shutter mode, among the first shutter mode and the second shutter mode.

### CROSS-REFERENCE TO RELATED APPLICATION

This application is based on and claims priority under 35 U.S.C. § 119 to Korean Patent Application No. 10-2024-0064801, filed on May 17, 2024, in the Korean Intellectual Property Office, the disclosure of which is incorporated by reference herein in its entirety.

### BACKGROUND

### 1. Field

The disclosure relates to an image sensor and an image processing device including the image sensor.

### 2. Description of Related Art

Image sensors, which capture images and convert the images into electrical signals, are used in various manner. For example, image sensors are used in consumer electronic devices, such as digital cameras, mobile phone cameras, and portable camcorders. Moreover, image sensors are used in cameras mounted on automobiles, security devices, and robots.

Image sensors may determine the amount of photocharges, which is the basis for an electrical signal, by adjusting the exposure time. Image sensors may adjust exposure time by using a rolling shutter method and a global shutter method. In this case, the rolling shutter method is a method of controlling the accumulation time of photocharges differently for each row of a pixel array, and the global shutter method is a method of controlling the accumulation time of photocharges equally for different rows of the pixel array.

### SUMMARY

One or more aspects of the disclosure provide an image sensor that outputs image data both in a global shutter mode and a rolling shutter mode in one frame.

One or more aspects of the disclosure provide an image sensor that perform an intra-scene dual conversion gain (iDCG) operation in a global shutter circuit.

According to an aspect of the disclosure, there is provided an image sensor including a pixel array including a plurality of pixels, wherein the plurality of pixels include: a first pixel including a first circuit configured to operate in a first shutter mode and a second circuit configured to operate in a second shutter mode; and a second pixel including a third circuit configured to operate only in the first shutter mode, among the first shutter mode and the second shutter mode, and wherein the first pixel is adjacent to the second pixel.

According to another aspect of the disclosure, there is provided an image processing device including: an image sensor including a plurality of pixels and a color filter array on the plurality of pixels; and an image signal processor configured to process and output data from the image sensor, wherein the plurality of pixels include: a first pixel including a first circuit configured to operate in a first shutter mode and a second circuit configured to operate in a second shutter mode, and a second pixel including a third circuit configured to operate only in the first shutter mode, among the first shutter mode and the second shutter mode, wherein the first pixel is adjacent to the second pixel, and wherein the image signal processor is configured to: receive setting information including information on one of an image and an imaging condition, and determine a processing mode of the data output from the image sensor based on the setting information.

According to an aspect of the disclosure, there is provided an image sensor including: a first chip including a plurality of rolling shutter circuit regions configured to readout a plurality of pixels based on a rolling shutter technique; and a second chip includes a plurality of global shutter circuit regions configured to readout out the plurality of pixels based on a global shutter technique, wherein a number of the plurality of global shutter circuit regions is less in a number of the plurality of rolling shutter circuit regions.

### BRIEF DESCRIPTION OF DRAWINGS

Embodiments of the disclosure will be more clearly understood from the following detailed description taken in conjunction with the accompanying drawings in which:

FIG. 1 is a block diagram of an image sensor according to an embodiment;

FIGS. 2A and 2B are timing diagrams illustrating operations in a global shutter mode and a rolling shutter mode;

FIGS. 3A to 3C illustrate implementation examples of a pixel array corresponding to a color filter array;

FIGS. 4A to 4C are examples of arrangement of pixels included in a pixel array, according to one or more embodiments;

FIGS. 5A and 5B are block diagrams illustrating components of a first pixel and a second pixel according to an embodiment;

FIGS. 6A and 6B illustrate stack structures of an image sensor according to an embodiment;

FIGS. 7A and 7B illustrate examples in which components of the first pixel and the second pixel are applied to the stack structures;

FIG. 8 illustrates a circuit diagram of the first pixel and the second pixel according to the embodiment;

FIG. 9 illustrates a circuit diagram of a first pixel and a second pixel according to another embodiment;

FIG. 10 illustrates a circuit diagram of a first pixel and a second pixel according to another embodiment;

FIGS. 11A to 11D illustrate outputs of pixels of an image sensor according to the disclosure;

FIGS. 12 and 13 are block diagrams schematically illustrating electronic devices including image sensors, according to one or more embodiments;

FIG. 14 is a diagram illustrating an image processing device according to an embodiment;

FIGS. 15A to 15C are diagrams illustrating outputs in a first operation mode according to an embodiment;

FIGS. 16A and 16B are diagrams illustrating outputs in a second operation mode according to an embodiment;

FIGS. 17A and 17B are diagrams illustrating outputs in a third operation mode according to an embodiment; and

FIG. 18 is a block diagram illustrating an electronic device including an image sensor, according to an embodiment.

### DETAILED DESCRIPTION

Hereinafter, various embodiments of the disclosure are described with reference to the attached drawings.

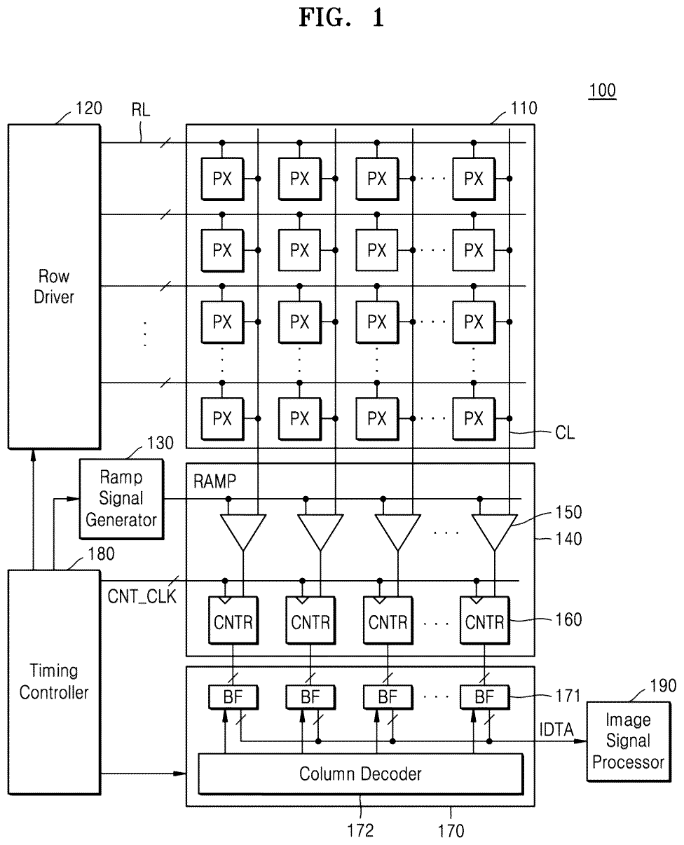

FIG. 1 is a block diagram of an image sensor according to an embodiment.

According to an embodiment, an image sensor 100 illustrated in FIG. 1 may be mounted on an electronic device including an image capturing function or a light sensing function. For example, the image sensor 100 may be mounted on an electronic device, such as a camera, a smartphone, a wearable device, an Internet of things (IoT) device, a home appliance, a tablet personal computer (PC), a personal digital assistant (PDA), a portable multimedia player (PMP), a navigation, a drone, or an advanced driver assistance system (ADAS). Also, the image sensor 100 may be mounted on electronic devices that are included, as components, in vehicles, furniture, manufacturing facility, doors, and various measurement devices. However, the disclosure is not limited thereto, and as such, the image sensor 100 may be implemented in other devices.

Referring to FIG. 1, the image sensor 100 may include a pixel array 110, a row driver 120, a ramp signal generator 130, an analog-to-digital conversion circuit 140 (hereinafter referred to as an ADC circuit), a data output circuit 170, and a timing controller 180. The image sensor 100 may be connected to an image signal processor 190. According to an embodiment, the image sensor 100 and the image signal processor 190 may form an image processing device. A configuration including the ramp signal generator 130, the ADC circuit 140, and the data output circuit 170 may be referred to as a readout circuit.

The pixel array 110 may be connected to a plurality of row lines RL, a plurality of column lines CL, and a plurality of pixels PX connected to the plurality of row lines RL and the plurality of column lines CL and arranged in rows and columns.

Each of the plurality of pixels PX may include a plurality of photoelectric conversion elements, and the plurality of pixels PX may detect light by using the plurality of photoelectric conversion elements and output image signals, which are electrical signals generated based on the detected light. For example, the plurality of photoelectric conversion elements may each include, but is not limited to, a photodiode, a photo transistor, and a photo gate or a pinned photodiode.

The plurality of pixels PX may each detect light in a certain spectral region. For example, the plurality of pixels (PX) may include a red pixel for converting light in the red spectrum region into an electrical signal, a green pixel for converting light in the green spectrum region into an electrical signal, and a blue pixel for converting light in the blue spectrum region into electrical signals. However, the disclosure is not limited thereto, and the plurality of pixels may further include white pixels. In another example, the plurality of pixels may also include pixels combined with different color configurations, such as yellow pixels, cyan pixels, and magenta pixels.

According to an embodiment, a color filter array may be provided over the plurality of pixels PX to transmit light in a certain spectrum region therethrough, and a color that may be detected by each of the plurality of pixels may be determined according to a color filter over each of the plurality of pixels PX. However, the disclosure is not limited thereto. In one or more embodiments, a photoelectric conversion element may also convert light in a certain wavelength band into an electrical signal according to a level of the electrical signal applied to the photoelectric conversion element.

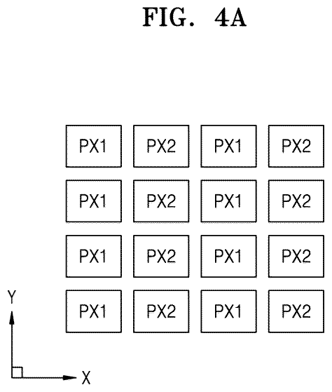

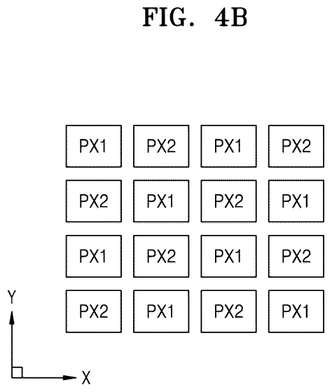

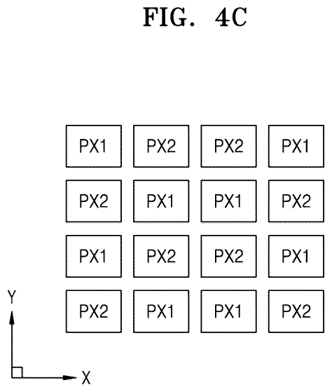

According to an embodiment, the plurality of pixels PX may include a first set of pixels PX and a second set of pixels PX. According to an embodiment, each of the first set of pixels may include a global shutter circuit and a rolling shutter circuit, and each of the second set of pixels may include only the rolling shutter circuit. For example, each of the second set of pixels may include only the rolling shutter circuit, among the global shutter circuit and the rolling shutter circuit. That is, each of the second set of pixels does not include the global shutter circuit. The image sensor according to an embodiment of the disclosure may further include a circuit capable of adjusting capacitance in a lower region of a chip in which the second set of pixels including only the rolling shutter circuit are provided, thereby additionally acquiring a high dynamic range (HDR) in an intra-scene dual conversion gain (iDCG). Also, a hybrid image may be obtained with one frame, and accordingly, image recombination and regeneration may be made by using only the respective advantages of a rolling shutter circuit and a global shutter circuit. According to an embodiment of the disclosure, hybrid may mean a mixture of a rolling shutter and a global shutter. A structure of the plurality of pixels PX according to an embodiment of the disclosure is described in detail with reference to FIGS. 4A to 4C below.

The row driver 120 drives the pixel array 110 row by row. The row driver 120 may decode a row control signal received from the timing controller 180, and select at least one of row lines connected to the pixel array 110 based on a decoded row control signal. For example, the row driver 120 may select at least one of row lines connected to the pixel array 110 in response to the decoded row control signal. For example, the row control signal may include an address signal. For example, the row driver 120 may generate a selection signal for selecting one of a plurality of rows. In addition, the pixel array 110 outputs a pixel signal, for example, a pixel voltage, from the row selected by the selection signal provided by the row driver 120. The pixel signal may include a reset signal and an image signal. The row driver 120 may transmit control signals for causing pixel signals to be output from the pixel array 110, and the plurality of pixels PX may output the pixel signals based on the control signals. The plurality of pixels PX may output the pixel signals in response to the control signals.

The ramp signal generator 130 may generate a ramp signal RAMP of which level increases or decreases at a preset slope under the control by the timing controller 180. For example, the ramp signal may be a ramp voltage. The ramp signal RAMP may be provided to each of a plurality of correlated double sampling (CDS) circuits 150 included in the ADC circuit 140.

The ADC circuit 140 may include the plurality of CDS circuits 150 and a plurality of counters (CNTRs) 160. The ADC circuit 140 may convert a pixel signal input from the pixel array 110 into a pixel value that is a digital signal. For example, the pixel signal may be a pixel voltage. Each pixel signal received through each of the plurality of column lines CL is converted into a pixel value, that is a digital signal, by each of the plurality of CDS circuits 150 and each of the plurality of counters (CNTRs) 160.

The plurality of CDS circuits 150 may compare pixel signals, for example, pixel voltages, received through the plurality of column lines CL with the ramp signal RAMP, and output comparison results as comparison result signals. In an example case in which a level of the ramp signal RAMP is equal to levels of the pixel signals, the plurality of CDS circuits 150 may output comparison signals that are shifted from a first level (to a second level. For example, the first level may be a logic high level and the second level may be a logic low level. A point at which a level of the comparison signal is shifted may be determined according to a level of the pixel signal. Hereinafter, for the sake of convenience of description, the first level is referred to as a high level, and the second level is referred to as a low level according to an embodiment of the disclosure. However, the disclosure is not limited thereto, and as such, the first level may be a low level and the second level may be a high level.

The plurality of CDS circuits 150 may sample pixel signals provided by the plurality of pixels PX according to a CDS method. The plurality of CDS circuits 150 may each sample a reset signal received as a pixel signal and compare the reset signal with the ramp signal RAMP to generate a comparison signal according to the reset signal. Thereafter, the plurality of CDS circuits 150 may each sample an image signal correlated to the reset signal and compare the image signal with the ramp signal RAMP to generate a comparison signal according to the image signal.

The plurality of counters 160 (CNTRs) may count level transition points of comparison result signals output from the plurality of CDS circuits 150 based on a counting clock signal CNT_CLK provided by the timing controller 180 and output counted values.

In one or more embodiments, the plurality of counters (CNTRs) 160 may include, but is not limited to, an up-counter, a calculation circuit, an up/down counter, or a bit-wise inversion counter. For example, the calculation circuit may be configured to sequentially increase a count value based on the counting clock signal CNT_CLK.

In one or more embodiments, the image sensor 100 may further include a counting code generator that generates a counting code and provides the counting code to each of the plurality of counters (CNTRs) 160. According to an embodiment, a value of the counting code may change periodically. For example, the counting code generator may generate the counting code by changing the value of the counting code periodically. According to an embodiment, the counting code may be a gray code. According to an embodiment, the plurality of counters (CNTRs) 160 may each include a latch circuit and a calculation circuit. The latch circuit may latch a code value of the counting code based on a level of the counting comparison signal being shifted. For example, the latch circuit may latch a code value of the counting code at a point in time when a level of the counting comparison signal is shifted. The latch circuit may latch each of a code value corresponding to a reset signal, for example, a reset value, and a code value corresponding to an image signal, for example, an image signal value. The calculation circuit may calculate the reset value and the image signal value to generate an image signal value from which a reset level of the pixel PX is removed. The plurality of counters (CNTRs) 160 may each output the image signal value from which the reset level is removed as a pixel value.

The data output circuit 170 may temporarily store the pixel value output from the ADC circuit 140 and then output the pixel value. The data output circuit 170 may include a plurality of column memories 171 (or referred to as a plurality of buffers BF) and a column decoder 172. The plurality of column memories 171 may store pixel values received from the plurality of counters (CNTRs) 160. In one or more embodiments, the plurality of column memories 171 may also be respectively included in the plurality of counters (CNTRs) 160. A plurality of pixel values respectively stored in the plurality of column memories 171 may be output as image data IDTA under the control by the column decoder 171.

The timing controller 180 may output a control signal to each of the row driver 120, the ramp signal generator 130, the ADC circuit 140, and the data output circuit 170, to control an operation or timing of each of the row driver 120, the ramp signal generator 130, the ADC circuit 140, and the data output circuit 170.

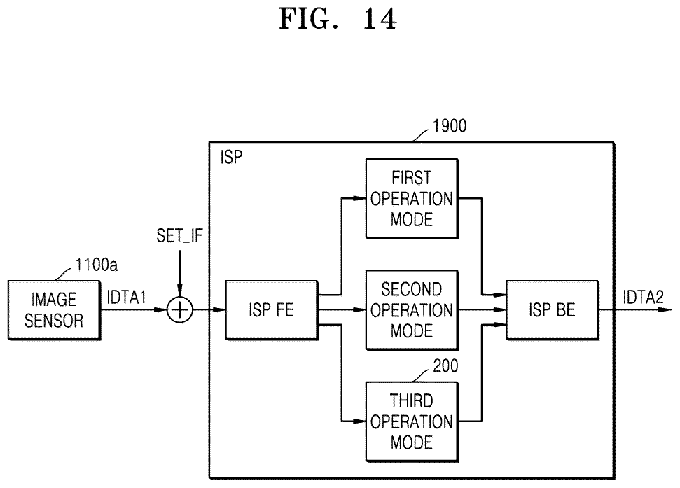

The image signal processor 190 may perform noise reduction processing, gain adjustment, waveform normalization processing, interpolation processing, white balance processing, gamma processing, edge emphasis processing, binning, and so on in response to the image data IDTA. In one or more embodiments, the image signal processor 190 may be configured by an external processor outside the image sensor 100. The image signal processor 190 may output the image data IDTA in one of a first operation mode, a second operation mode, and a third operation mode. This is described below with reference to FIG. 14 below.

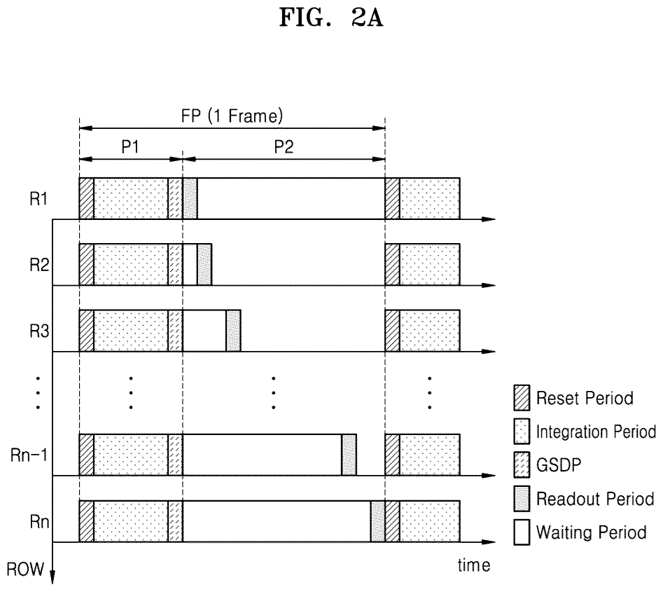

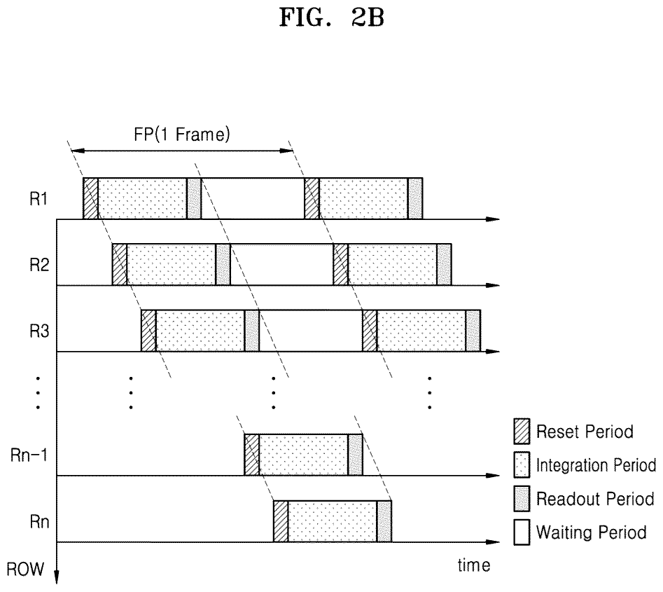

FIGS. 2A and 2B are timing diagrams illustrating operations in a global shutter mode and a rolling shutter mode.

Referring to FIGS. 1 and 2A, the image sensor 100 may operate in the global shutter mode.

According to an embodiment, one frame period (FP) may include a first period P1 and a second period P2. In the first period (P1), the plurality of pixels PX of the pixel array 110 may simultaneously perform a reset operation, an exposure operation, and a global signal dumping operation, and in the second period P2, the plurality of pixels PX of the pixel array 110 may sequentially perform a read operation. For example, in the first period (P1), the plurality of rows of the pixel array 110 may simultaneously perform the reset operation, the exposure operation, and the global signal dumping operation, and in the second period P2, the plurality of rows of the pixel array 110 may sequentially perform a read operation. The second period P2 may be referred to as a frame read-out period. For example, the plurality of rows may include a first row R1 to an n-th row Rn.

The first period P1 may include a reset period, an integration period, and a global signal dumping period (GSDP). In the reset period, the plurality of pixels PX may perform a reset operation of removing charges accumulated in a photodiode (and/or a floating diffusion node). In the integration period, the plurality of pixels PX may perform an accumulation operation of generating and accumulating photocharges corresponding an optical signal received by the photodiode. In the GSDP period, the plurality of pixels PX may store a reset signal according to a reset level of the floating diffusion node and an image signal corresponding to the photocharges accumulated in the photodiode respectively in at least two capacitors included in each of the plurality of pixels PX.

In the second period P2, a rolling readout operation may be performed in which a readout operation is sequentially performed for each row during the readout period. For example, a readout operation of the first row R1 of the pixel array 110 is performed, and after the readout operation of the first row R1 of the pixel array 110 is performed, the readout operation of the second row R2 may be performed. In addition, after the readout operation of the second row R2 is performed, the readout operation for a third row R3 may be performed. During the readout operation, the reset signal and the image signal respectively stored in at least two capacitors during the GSDP may be output from each of the plurality of pixels PX as a pixel signal.

Referring to FIGS. 1 and 2B, the image sensor 100 may operate in the rolling shutter mode.

In one frame period FP, the plurality of rows (for example, the first row R1 to the n-th row Rn) of the pixel array 110 may sequentially perform a reset operation, an exposure operation, and a readout operation.

According to an embodiment, pixels PX in one row may perform a reset operation during a reset period, perform an accumulation operation during the accumulation period, and output a reset signal corresponding to a reset level of a floating diffusion node and an image signal corresponding to the photocharges generated by a photodiode, as a pixel signal, during the readout period. For example, the reset signal may be a reset voltage and the image signal may be an image voltage. Readout periods of the plurality of rows of the pixel array 110 do not overlap each other. After the readout period, the pixels PX in one row may perform a reset operation again after a waiting period. In the embodiment, a waiting period may be set such that a readout period in the next frame period of at least one row (for example, the first row R1 and the second row R2, and so on) that is initially read out during the frame period FP does not overlap a readout period in the current frame period of at least one other row (for example, an n−1-th row Rn−1, the n-th row Rn, and so on) that is finally read out in the frame period FP.

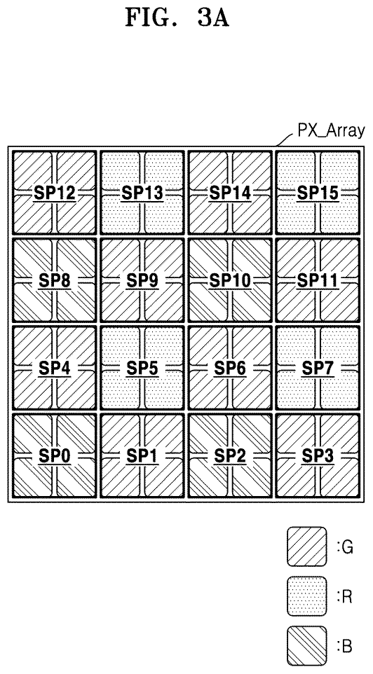

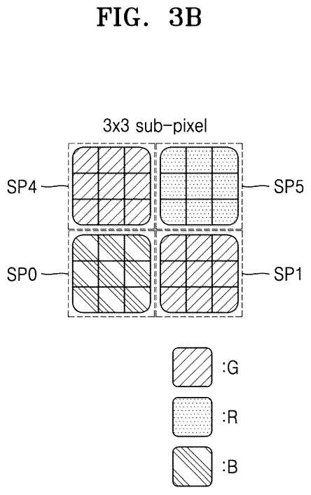

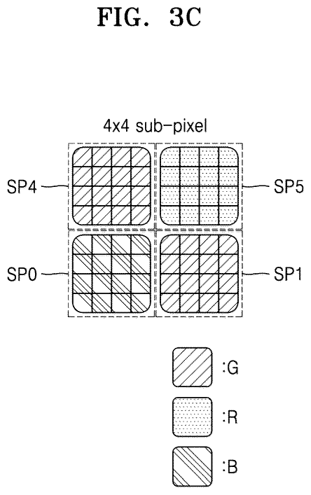

FIGS. 3A to 3C illustrate implementation examples of a pixel array corresponding to a color filter array.

Referring to FIG. 3A, a pixel array PX_Array may include a number of pixels arranged in a plurality of rows and columns. According to an embodiment, the pixel array PX_Array may include shared pixels, and each shared pixel, which is defined as a unit including pixels arranged in, for example, two rows and two columns, may include four subpixels. In other words, the shared pixel may include four photodiodes respectively corresponding to four subpixels. The pixel array PX_Array may include first to sixteenth shared pixels SP0 to SP15. The pixel array PX_Array may include a color filter such that the shared pixels SP0 to SP15 may sense various colors. For example, the color filter may include filters that sense red (R), green (G), and blue (B), and one of the plurality of shared pixels SP0 to SP15 may include subpixels in which filters of the same color are arranged. For example, the first shared pixel SP0, the third shared pixel SP2, the ninth shared pixel SP8, and the 11^{th} shared pixel SP10 may include subpixels having a blue (B) color filter, the second shared pixel SP1, the fourth shared pixel SP3, the fifth shared pixel SP4, the seventh shared pixel SP6, the tenth shared pixel SP9, the 12^{th} shared pixel SP11, the 13^{th} shared pixel SP12, and the 15^{th} shared pixel SP14 may include subpixels having a green (G) color filter, and the sixth shared pixel SP5, the eighth shared pixel SP7, the 14^{th} shared pixel SP13, and the 16^{th} shared pixel SP15 may include subpixels having a red (R) color filter. Also, a group including the first shared pixel SP0, the second shared pixel SP1, the fifth shared pixel SP4, and the sixth shared pixel SP5, a group including the third shared pixel SP2, the fourth shared pixel SP3, the seventh shared pixel SP6, and the eighth shared pixel SP7, a group including the ninth shared pixel SP8, the tenth shared pixel SP9, the 13^{th} shared pixel SP12, and the 14^{th} shared pixel SP13, and a group including the 11^{th} shared pixel SP10, the 12^{th} shared pixel SP11, the 15^{th} shared pixel SP14, and the 16^{th} shared pixel SP15 may be arranged in the pixel array PX_Array to each correspond to a Bayer pattern. According to an embodiment, a group including the first shared pixel SP0, the second shared pixel SP1, the fifth shared pixel SP4, and the sixth shared pixel SP5, a group including the third shared pixel SP2, the fourth shared pixel SP3, the seventh shared pixel SP6, and the eighth shared pixel SP7, a group including the ninth shared pixel SP8, the tenth shared pixel SP9, the 13^{th} shared pixel SP12, and the 14^{th} shared pixel SP13, and a group including the 11^{th} shared pixel SP10, the 12^{th} shared pixel SP11, the 15^{th} shared pixel SP14, and the 16^{th} shared pixel SP15 may each correspond to a color filter array (CFA) block.

However, this is only an example, and the pixel array PX_Array according to the embodiment may include various types of color filters. For example, a color filter may include filters for sensing colors of yellow, cyan, magenta, and green. Also, the color filter may include filters for sensing colors of red, green, blue, and white. Also, the pixel array PX_Array may include more shared pixels, and the first to 16^{th} shared pixels SP0 to SP15 may be arranged in various ways.

Referring to FIG. 3B, the first shared pixel SP0, the second shared pixel SP1, the fifth shared pixel SP4, and sixth shared pixel SP5 may each include 9 subpixels. For example, the first shared pixel SP0 may include nine subpixels having a blue (B) color filter, the second shared pixel SP1 and the fifth shared pixel SP4 may each include nine subpixels having a green (G) color filter, and the sixth shared pixel SP5 may include nine subpixels having a red (R) color filter. In one or more embodiments, the first, second, fifth, and sixth shared pixels SP0, SP1, SP4, and SP5 may be referred to as nona cells.

Referring to FIG. 3C, the first shared pixel SP0, the second shared pixel SP1, the fifth shared pixel SP4, and sixth shared pixel SP5 may each include 16 subpixels. The first shared pixel SP0 may include 16 subpixels having a blue (B) color filter, and the second shared pixel SP1 and the fifth shared pixel SP4 may each include 16 subpixels having a green (G) color filter. The sixth shared pixel SP5 may include 16 subpixels having a red (R) color filter. In one or more embodiments, the first shared pixel SP0, the second shared pixel SP1, the fifth shared pixel SP4, and sixth shared pixel SP5 may be referred to as hexadeca cells.

FIGS. 4A to 4C are examples of arrangement of pixels included in a pixel array, according to one or more embodiments.

Referring to FIGS. 4A to 4C, pixels included in the pixel array 110 (illustrated in FIG. 1) may include first pixels PX1 and second pixels PX2. FIGS. 4A to 4C illustrate examples in which the first pixels PX1 and the second pixels PX2 are arranged in a 4×4 array including a total of 16 pixels, but the number of pixels included in a pixel array is not limited thereto. Also, although FIGS. 4A to 4C illustrate that the number of first pixels PX1 is equal to the number of second pixels PX2, this is only an example, and the number of first pixels PX1 and the number of second pixels PX2 included in the pixel array may be different from each other.

Circuit structures of the first pixels PX1 may be slightly different from circuit structures of the second pixels PX2. According to an embodiment, the first pixels PX1 may each operate in either a first shutter mode or a second shutter mode. The second pixels PX2 may each operate only in the first shutter mode. The first pixels PX1 may each include both a circuit capable of operating in the first shutter mode and a circuit capable of operating in the second shutter mode. The second pixels PX2 may each include only a circuit capable of operating in the first shutter mode. According to an embodiment, the first shutter mode may include a rolling shutter mode. According to an embodiment, the second shutter mode may include a global shutter mode. The rolling shutter mode may refer to a mode in which charges accumulated in a floating diffusion node are read out by using a rolling shutter method. The global shutter mode may refer to a mode in which charges accumulated in the floating diffusion node are read out by using a global shutter method. Specific circuit structures of the first pixels PX1 and the second pixels PX2 are described below.

Referring again to FIGS. 4A to 4C, the first pixels PX1 that may operate in either the first shutter mode or the second shutter mode, and the second pixels PX2 that may operate only in the first shutter mode may be arranged adjacent to each other in a pixel array. Referring to FIG. 4A, an example, in which the first pixels PX1 and the second pixels PX2 are arranged sequentially, is illustrated. Referring to FIG. 4A, the first pixels PX1 and the second pixels PX2 may be alternately arranged in the X-axis direction, and the same type pixels may be arranged in the Y-axis direction. Referring to FIG. 4B, the first pixels PX1 and the second pixels PX2 may be alternately arranged in the X-axis direction, and the first pixels PX1 and the second pixels PX2 may be alternately arranged in the Y-axis direction. Referring to FIG. 4C, the first pixels PX1 and the second pixels PX2 may be arranged adjacent to each other in the X-axis direction, and the first pixels PX1 and the second pixels PX2 may be alternately arranged in the Y-axis direction. Referring to FIG. 4C, the second pixels PX2 may be adjacent to each other, or the first pixels PX1 may be adjacent to each other.

Referring to FIGS. 4A to 4C, the first pixels PX1 and the second pixels PX2 may be arranged adjacent to each other in various patterns. It should be noted that, in addition to the examples illustrated in FIGS. 4A to 4C, the first pixels PX1 and the second pixels PX2 may be arranged adjacent to each other in various other patterns. According to an embodiment, the first pixels PX1 and the second pixels PX2 may be adjacent to each other in the X-axis direction, may be adjacent to each other in the Y-axis direction, or may be arranged adjacent to each other in a diagonal direction. Also, the first pixels PX1 and the second pixels PX2 may not be arranged in a regular pattern as illustrated in FIGS. 4A to 4C.

According to an embodiment of the disclosure, pixels operating in a global shutter mode and pixels operating in a rolling shutter mode are simultaneously arranged in an image sensor, and an output result in the global shutter mode and an output result in the rolling shutter mode may be simultaneously acquired within one frame by spatially separating the pixels. Accordingly, it is possible to acquire a hybrid image in one frame by using only the advantages of the global shutter and the rolling shutter.

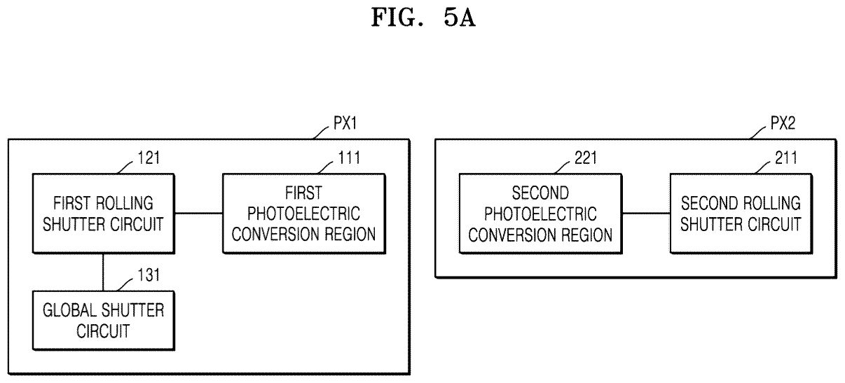

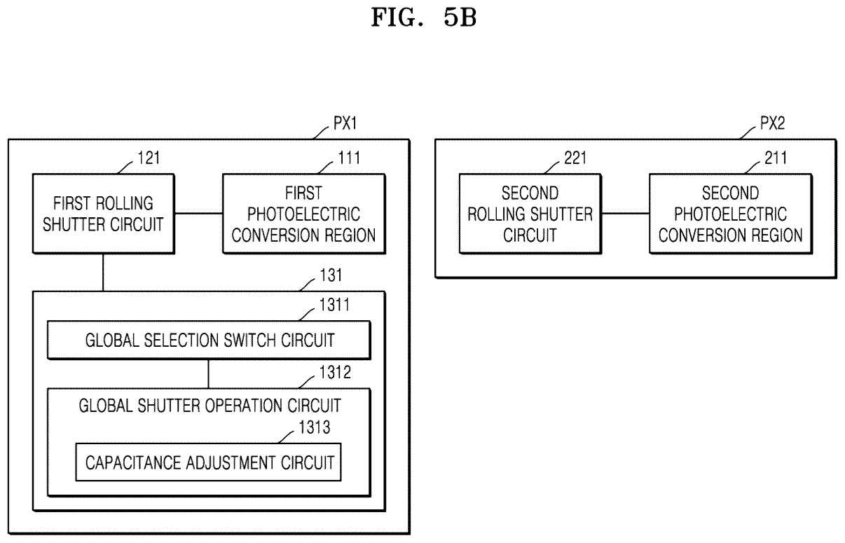

FIGS. 5A and 5B are block diagrams illustrating components of a first pixel and a second pixel according to an embodiment.

Referring to FIGS. 5A and 5B, the first pixel PX1 may include a first photoelectric conversion region 111, a first rolling shutter circuit 121, and a global shutter circuit 131. The global shutter circuit 131 may include a global selection switch circuit 1311 and a global shutter operation circuit 1312. The global shutter operation circuit 1312 may further include a capacitance adjustment circuit 1313. The second pixel PX2 may include a second photoelectric conversion region 211 and a second rolling shutter circuit 221.

The first photoelectric conversion region 111 may include at least one photoelectric conversion element. According to an embodiment, the at least one photoelectric conversion element included in the first photoelectric conversion region 111 may be connected to a first floating diffusion node through at least one transfer transistor. The second photoelectric conversion region 211 may include at least one photoelectric conversion element. According to an embodiment, the least one photoelectric conversion element included in the second photoelectric conversion region 211 may be connected to a second floating diffusion node through at least one transfer transistor.

The first photoelectric conversion region 111 included in the first pixel PX1 of FIGS. 5A and 5B may be connected to the first rolling shutter circuit 121 and enable the first pixel PX1 to operate in a rolling shutter mode, and the second photoelectric conversion region 211 included in the second pixel PX2 may be connected to the second rolling shutter circuit 221 and enable the second pixel (PX2) to operate in a rolling shutter mode. According to an embodiment, the first rolling shutter circuit 121 and the second rolling shutter circuit 221 may each include a source follower transistor and a rolling select transistor. The first rolling shutter circuit 121 and the second rolling shutter circuit 221 may each output a pixel signal according to a rolling shutter operation of each pixel through a separate output line.

According to an embodiment, in the first pixel PX1, the global shutter circuit 131 may be connected to the first rolling shutter circuit 121. The global shutter circuit 131 may output a pixel signal according to a global shutter operation of the first pixel PX1. The global selection switch circuit 1311 included in the global shutter circuit 131 may be connected between the first rolling shutter circuit 121 and the global shutter operation circuit 1312. The global selection switch circuit 1311 may include at least one transistor. According to an embodiment of the disclosure, based on the transistor included in the global selection switch circuit 1311 being turned on, the first pixel PX1 may operate in the global shutter mode.

The global shutter operation circuit 1312 may be connected to an output terminal of the global selection switch circuit 1311. In an example case in which at least one transistor included in the global selection switch circuit 1311 is turned on, the global shutter operation circuit 1312 enables one or more transistors included in the global shutter operation circuit 1312 to operate in the global shutter mode The global shutter operation circuit 1312 may include the capacitance adjustment circuit 1313. The capacitance adjustment circuit 1313 may include a plurality of transistors connected in series and may adjust a conversion gain in a global shutter operation by controlling turn-on and turn-off of the plurality of transistors.

The first pixel PX1 according to an embodiment of the disclosure may operate in the global shutter mode or in the rolling shutter mode. For example, the first pixel PX1 according to an embodiment of the disclosure may operate in the global shutter mode or in the rolling shutter mode based on a plurality of transistors included in the first pixel PX1. The second pixel PX2 according to an embodiment of the disclosure may operate in the rolling shutter mode. According to an embodiment of the disclosure, outputs of a plurality of pixels included in one frame includes an output of the rolling shutter mode and an output of the global shutter mode, and accordingly, advantages of each output mode may be utilized.

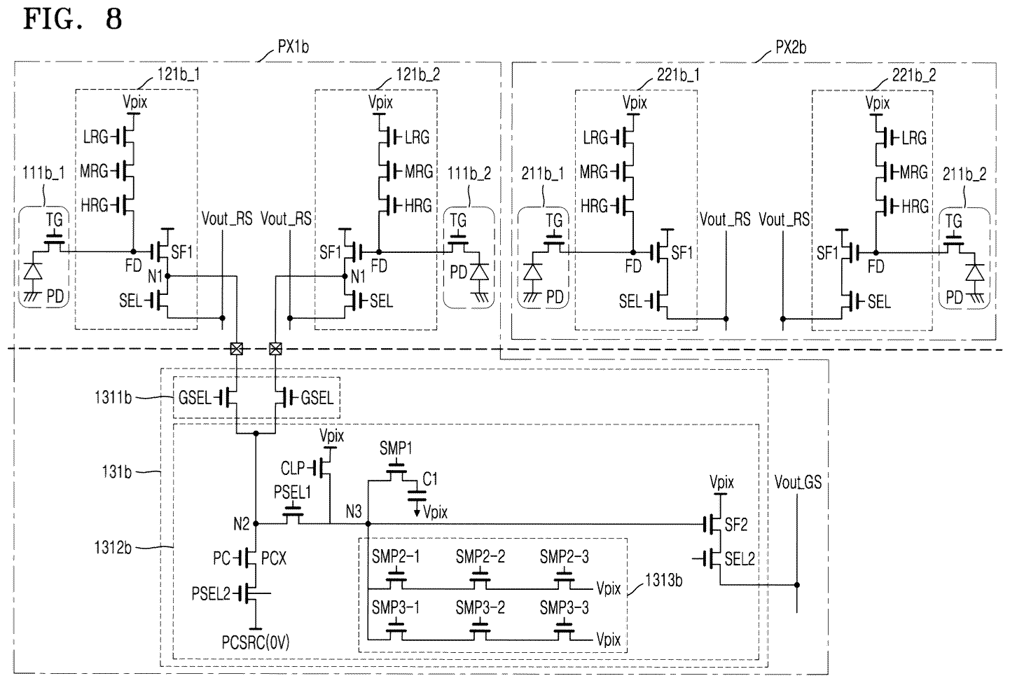

Specific circuit structures of the first pixel PX1 and the second pixel PX2 according to an embodiment of the disclosure are described in detail with reference to FIG. 8 below.

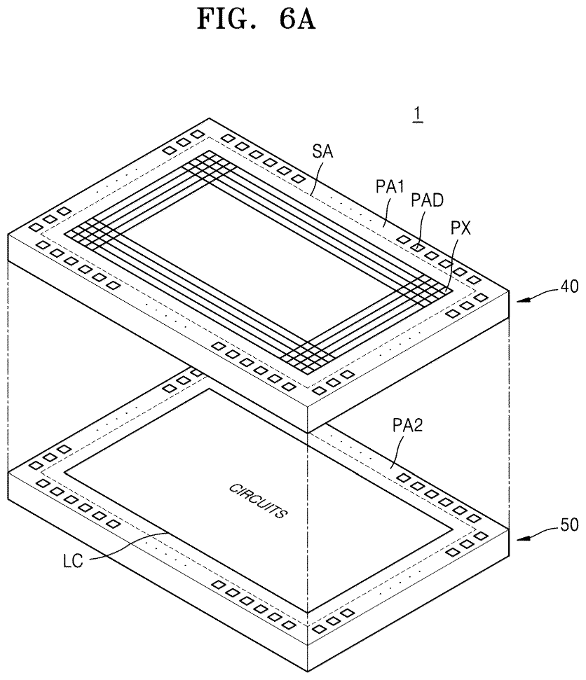

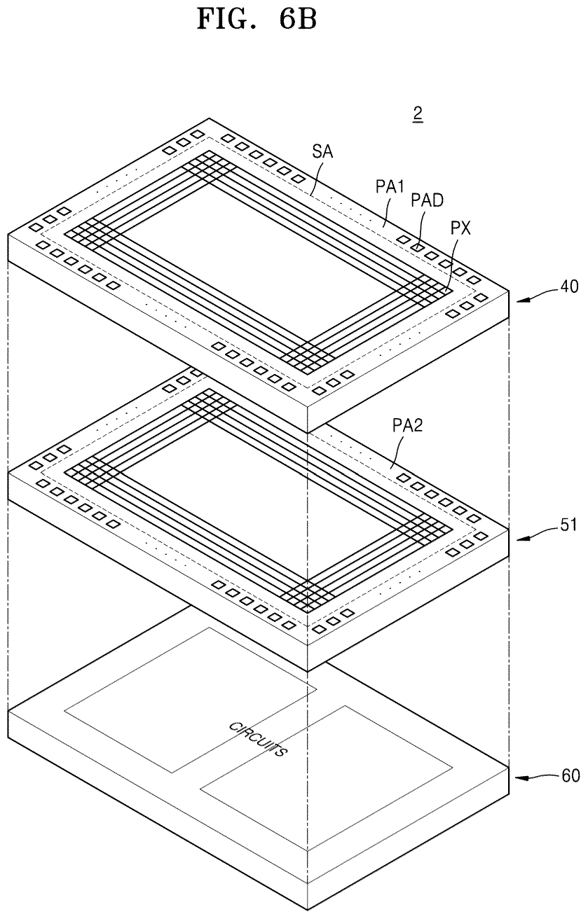

FIGS. 6A and 6B illustrate stack structures of an image sensor according to an embodiment.

Referring to FIG. 6A, an image sensor 1 may include a first chip 40 and a second chip 50. According to an embodiment, the first chip 40 may be referred to as an upper chip 40 and the second chip may be referred to as a lower chip 50. However, the disclosure is not thereto, and as such, according to another embodiment, the first chip 40 may be referred to as a lower chip and the second chip may be referred to as an upper chip. The upper chip 40 may include a sensing region SA in which a plurality of pixels PX are provided, a circuit region LC in which elements for driving the plurality of pixels PX are provided, and a pad region PA1 around the sensing region SA and the circuit region LC. A plurality of upper pads PAD are arranged in the pad region PA1, and the plurality of upper pads PAD may be connected to components provided on the lower chip 50 through vias or so on.

The lower chip 50 may include a circuit region LC, and the circuit region LC may include a peripheral circuit of the pixel array 110, such as the row driver 120, the ADC circuit 140, and the ramp signal generator 130, the timing controller 180, and the image signal processor 190. In one or more embodiments, the lower chip 50 may include a memory region and a dummy region. Memory elements, such as dynamic random access memory (DRAM) elements or static random access memory (SRAM) elements, may be arranged in the memory region. However, the memory elements in the memory region are not limited to the DRAM elements or SRAM elements. The dummy region may have a function of supporting the upper chip 40 rather than storing data.

Referring to FIG. 6B, an image sensor 2 may include a plurality of stacked chips. For example, the image sensor 2 may include a first chip 40, a second chip 60 and a third chip 51. For example, the first chip 40 may be referred to as an upper chip 40, the second chip 60 may be referred to as a lower chip 60, and the third chip 51 may be referred to as intermediate chip 51. For example, a pixel array 110 may be formed in the upper chip 40 and an intermediate chip 51, and a peripheral circuit or memory of the pixel array 110 may be formed in a lower chip 60. According to an embodiment, photodiodes and some transistors of pixels may be formed in the upper chip 40, and the other transistors and capacitors C1, C2, and C3 may be formed in the intermediate chip 51.

The lower chip 60 may include a circuit region LC, and peripheral circuits of the pixel array (110 of FIG. 1) may be formed in the circuit region LC. In one or more embodiments, the lower chip 60 may include a memory region and a dummy region.

In one or more embodiments, the upper chip 40 and the intermediate chip 51 may be stacked on each other at a wafer level, and the lower chip 60 may be attached to a lower portion of the intermediate chip 51 at a chip level.

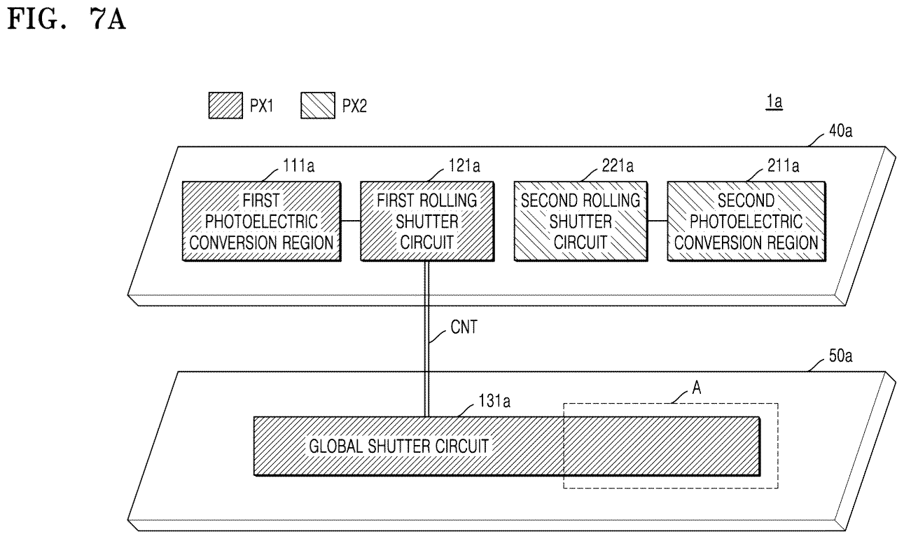

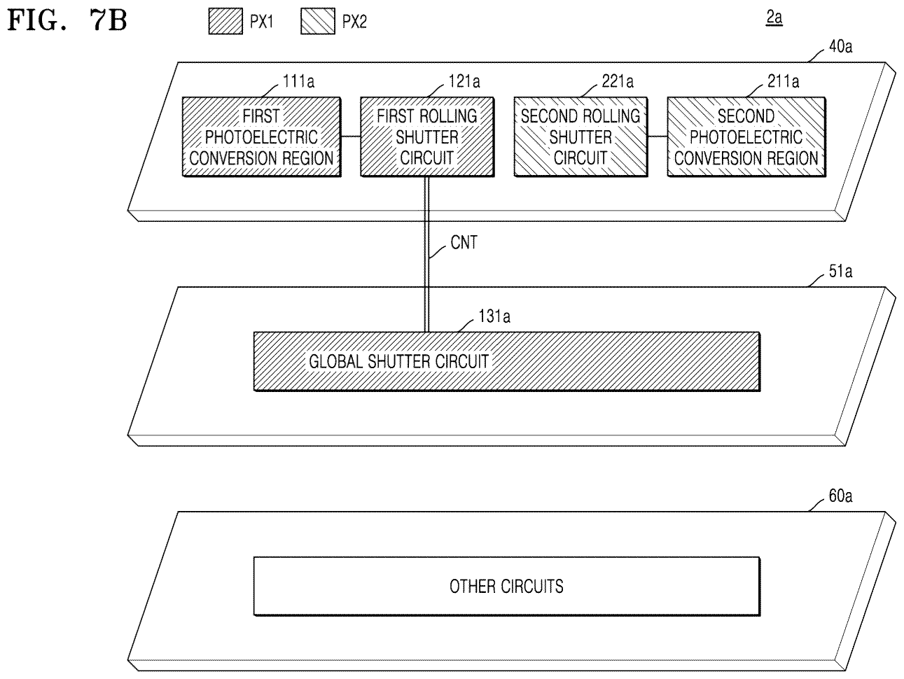

FIGS. 7A and 7B illustrates examples in which components of a first pixel and a second pixel are applied to a stack structure.

Referring to FIG. 7A, the image sensor 1a may include an upper chip 40a and a lower chip 50a. Descriptions of the upper chip 40a and the lower chip 50a which may correspond to the previous description of the upper chip 40 and the lower chip 50 of FIG. 6A, and as such, redundant descriptions thereof are omitted below.

According to an embodiment, a first pixel PX1 and a second pixel PX2 may be arranged on the upper chip 40a and the lower chip 50a. According to an embodiment, a first photoelectric conversion region 111a and a first rolling shutter circuit 121a included in the first pixel PX1 may be arranged in the upper chip 40a. A second photoelectric conversion region 211a and a second rolling shutter circuit 221a included in the second pixel PX2 may be arranged in the upper chip 40a. A global shutter circuit 131a included in the first pixel PX1 may be arranged in the lower chip 50a. That is, the first rolling shutter circuit 121a and the global shutter circuit 131a included in the first pixel PX1 may be in different chips. According to an embodiment, the first rolling shutter circuit 121a and the global shutter circuit 131a in different chips may be connected to each other through a vertical contact CNT. According to another embodiment, the first rolling shutter circuit 121a and the global shutter circuit 131a may be connected to each other through metal-to-metal bonding (C2C). Also, the global shutter circuit 131a may extend to a lower region of the region in which the second photoelectric conversion region 211a and the second rolling shutter circuit 221a included in the second pixel PX2 are arranged. The lower region of the region in which the second photoelectric conversion region 211a and the second rolling shutter circuit 221a included in the second pixel PX2 are arranged may refer to a region of a second chip corresponding to a region of a first chip in which the second pixel PX2 is formed. The lower region of the region in which the second photoelectric conversion region 211a and the second rolling shutter circuit 221a included in the second pixel PX2 are arranged may refer to a region of a lower chip formed at the same position as the region in which the second pixel PX2 is provided.

According to an embodiment of the disclosure, the second pixel PX2 including only a rolling shutter circuit may not include a global shutter circuit. Accordingly, the lower chip 50a under a chip (for example, the upper chip 40a) in which the second pixel PX2 is formed may have a free space A corresponding thereto. According to an embodiment of the disclosure, capacitors and transistors included in a global shutter circuit of the first pixel PX1 may be additionally arranged in the free space A, and accordingly, high-resolution hardware may be implemented, and HDR limitations in dual conversion gain may be reduced.

Referring to FIG. 7B, an image sensor 2a may include an upper chip 40a, an intermediate chip 51a, and a lower chip 60a. Because description of the upper chip 40a, the intermediate chip 51a, and the lower chip 60a may correspond to the previous description of the upper chip 40, the intermediate chip 51, and the lower chip 60 of FIG. 6B, redundant descriptions thereof are omitted below.

A first pixel PX1 and a second pixel PX2 may be arranged in the upper chip 40a and the intermediate chip 50a. According to an embodiment, a first photoelectric conversion region 111a and a first rolling shutter circuit 121a included in the first pixel PX1 may be arranged in the upper chip 40a. A second photoelectric conversion region 211a and a second rolling shutter circuit 221a included in the second pixel PX2 may be arranged in the upper chip 40a. A global shutter circuit 131a included in the first pixel PX1 may be arranged in the intermediate chip 50a. The first rolling shutter circuit 121a and the global shutter circuit 131a included in the first pixel PX1 may be arranged in different chips. According to an embodiment, the first rolling shutter circuit 121a and the global shutter circuit 131a in different chips may be connected to each other through a vertical contact CNT. The global shutter circuit 131a may extend to a lower region of the region in which the second photoelectric conversion region 211a and the second rolling shutter circuit 221a included in the second pixel PX2 are arranged.

Although FIGS. 7A and 7B illustrates only the arrangement structure of one first pixel PX1 and one second pixel PX2 for the sake of convenience of description, it should be noted that a plurality of first pixels and a plurality of second pixels may be arranged in an image sensor.

According to an embodiment, a rolling shutter circuit region capable of reading out a plurality of pixels by using a rolling shutter method may be arranged in the upper chip 40a, and a global shutter circuit region capable of reading out a plurality of pixels by using a global shutter method may be arranged in the intermediate chip 51a or the lower chip 50a or 60a. The global shutter method may be referred to as a global shutter technique and the rolling shutter method may be referred to as a rolling shutter technique. Referring to FIGS. 7A and 7B, the number of global shutter circuit regions of a plurality of pixels may be less than the number of rolling shutter circuit regions. Referring to FIGS. 7A and 7B, the number of global shutter circuit regions may be 1, and the number of rolling shutter circuit regions may be 2. Because a second pixel that does not include a global shutter circuit may be provided, the number of global shutter circuit regions may be less than the number of rolling shutter circuit regions. The global shutter circuit region may be electrically connected to at least one rolling shutter circuit region in the upper chip 40a, and the global shutter circuit region may extend to a lower region of a rolling shutter circuit region that is not electrically connected to the global shutter circuit region.

FIG. 8 illustrates a circuit diagram of a first pixel and a second pixel according to an embodiment.

Referring to FIG. 8, circuit diagrams of a first pixel PX1b and a second pixel PX2b are illustrated. The first pixel PX1b may include first photoelectric conversion regions 111b_1 and 111b_2, first rolling shutter circuits 121b_1 and 121b_2, and a global shutter circuit 131b. According to an embodiment, control signals may be applied to a plurality of transistors included in the first rolling shutter circuits 121b_1 and 121b_2 and the global shutter circuit 131b. According to an embodiment, at least some of the control signals may be applied to the row driver 120 of FIG. 1.

Referring to FIG. 8, the first photoelectric conversion regions 111b_1 and 111b_2 of the first pixel PX1b may respectively include photodiodes PD and transfer transistors TG. The photodiodes PD may each generate photo charges that vary depending on the intensity of light. For example, the photodiodes PD may each generate charges, that are, electrons of negative charges and holes of positive charges, in proportion to the amount of incident light. Referring to FIG. 8, the transfer transistors TG may each be connected between the photodiode PD and a floating diffusion node FD. A first terminal of the transfer transistor TG may be connected to an output terminal of the photodiode PD, and a second terminal of the transfer transistor TG may be connected to the floating diffusion node FD. The transfer transistors TG may be turned on or off based on a transfer control signal received from the row driver 120 in FIG. 1. For example, the transfer transistors TG may be turned on or off in response to the transfer control signal. The transfer transistor TG may be turned on to transfer photo charges generated by the photodiode PD to the floating diffusion node FD. The number of transfer transistors TG may correspond to the number of photodiodes PD. According to the embodiment of FIG. 8, the first pixel PX1b may have a 2PD structure including two photodiodes PD. However, the disclosure is not limited thereto, and the number of photodiodes PD and transfer transistors TG included in each of the first photoelectric conversion regions 111b_1 and 111b_2 may be plural. In an example case in which the photodiodes PD and the transfer transistors TG included in the first photoelectric conversion regions 111b_1 and 111b_2 are plural, the floating diffusion node FD may be shared.

The first rolling shutter circuits 121b_1 and 121b_2 may each include a reset transistor LRG, a first conversion gain control transistor HRG, a second conversion gain control transistor MRG, a source follower transistor SF1, and a rolling select transistor SEL. The reset transistor LRG may reset the charges accumulated in the floating diffusion node FD. A pixel voltage VPIX may be applied to a first terminal of the reset transistor LRG, and a second terminal of the reset transistor LRG may be connected to a first terminal of the second conversion gain control transistor MRG. The reset transistor LRG may be turned on or off based on a reset control signal received from the row driver 120 in FIG. 1. For example, the reset transistor LRG may be turned on or off based on a reset control signal received from the row driver 120 in FIG. 1. For example, the reset transistor LRG may be turned on or off in response to the reset control signal. In an example case in which the reset transistor LRG, the first conversion gain control transistor HRG, and the second conversion gain control transistor MRG are turned on, the charges accumulated in the floating diffusion node FD may be discharged, and accordingly, the floating diffusion node FD may be reset.

The first conversion gain control transistor HRG and the second conversion gain control transistor MRG may adjust a conversion gain (CG) of the floating diffusion node FD. The conversion gain refers to a rate at which the charges accumulated in the floating diffusion node FD are converted into a voltage. The conversion gain may vary depending on capacitance of the floating diffusion node FD. In an example case in which the capacitance increases, the conversion gain may decrease, and in an example case in which the capacitance decreases, the conversion gain may increase.

The first conversion gain control transistor HRG and the second conversion gain control transistor MRG may be turned on or off based on a gain control signal. For example, the first conversion gain control transistor HRG and the second conversion gain control transistor MRG may be turned on or off based on a gain control signal. For example, the first conversion gain control transistor HRG and the second conversion gain control transistor MRG may be turned on or off in response to the gain control signal. In an example case in which the first conversion gain control transistor HRG and the second conversion gain control transistor MRG are turned on, the capacitance of the floating diffusion node FD may increase, and the conversion gain may decrease, and in an example case in which the first conversion gain control transistor HRG and the second conversion gain control transistor MRG are turned off, the capacitance of the floating diffusion node FD may decrease, and the conversion gain may increase. Therefore, the first pixel PX1b including the first photoelectric conversion regions 111b_1 and 111b_2 may operate in a high conversion gain (HCG) mode or low conversion gain (LCG) mode according to turn-on and turn-off of the first conversion gain control transistor HRG and the second conversion gain control transistor MRG. The first pixel PX1b may operate in a dual conversion gain mode, and the conversion gain mode may be determined by turn-on and turn-off of the first conversion gain control transistor HRG and the second conversion gain control transistor MRG.

A pixel voltage VPIX may be applied to a first terminal of the source follower transistor SF1, and a second terminal of the source follower transistor SF1 may be connected to a first output node N1. The source follower transistor SF1 is a buffer amplifier and may buffer signals according to the amount of charges accumulated in the floating diffusion node FD. A potential of the floating diffusion node FD changes depending on the amount of charges accumulated in the floating diffusion node FD, and the source follower transistor SF1 may amplify a potential change in the floating diffusion node FD and output the amplified potential change to the first output node N1. The source follower transistor SF1 may operate as a source follower and output a voltage corresponding to a voltage of the floating diffusion node FD to the first output node N1.

A first terminal of the rolling select transistor SEL may be connected to the source follower transistor SF1, and a second terminal of the rolling select transistor SEL may be connected to a first output line Vout_RS. The rolling select transistor SEL may be turned on or off based on a rolling select control signal. For example, the rolling select transistor SEL may be turned on or off in response to the rolling select control signal. In an example case in which the rolling select transistor SEL is turned on, a voltage corresponding to the first output node N1 may be output to the first output line Vout_RS. In this case, a voltage to be output may be output in a rolling shutter manner.

The first rolling shutter circuits 121b_1 and 121b_2 included in the first pixel PX1 may control outputs of the photodiodes included in the first photoelectric conversion regions 111b_1 and 11b_2 such that the outputs of the photodiodes are output in a shutter operation mode. According to an embodiment, the first rolling shutter circuits 121b_1 and 121b_2 may respectively output the outputs of the photodiodes included in the first photoelectric conversion regions 111b_1 and 111b_2 respectively through the first output lines Vout_RS, and the conversion gain of the output in the rolling shutter operation mode may be adjusted by the first conversion gain control transistor HRG and the second conversion gain control transistor MRG.

The second pixel PX2b may include second photoelectric conversion regions 211b_1 and 211b_2 and second rolling shutter circuits 221b_1 and 221b_2. Components and operations of the second photoelectric conversion regions 211b_1 and 211b_2 and the second rolling shutter circuits 221b_1 and 221b_2 included in the second pixel PX2b may correspond to the components and operations of the first photoelectric conversion region regions 111b_1 and 111b_2 and the first rolling shutter circuits 121b_1 and 121b_2 included in the first pixel PX1b. The components and operations of the first photoelectric conversion regions 111b_1 and 111b_2 and the first rolling shutter circuits 121b_1 and 121b_2 included in the first pixel PX1b are described above, and accordingly, redundant descriptions thereof are omitted below.

The global shutter circuit 131b of the first pixel PX1b may include a global selection switch circuit 1311b. The global selection switch circuit 1311b may be between the first rolling shutter circuits 121b_1 and 121b_2 and a second node N2. The global selection switch circuit 1311b may be connected between the first output nodes N1 of the first rolling shutter circuits 121b_1 and 121b_2 and the second node N2. The first output node N1 may be between the source follower transistor SF1 and the rolling select transistor SEL. The second node N2 may be connected to an output terminal of the global selection switch circuit 1311b. The global selection switch circuit 1311b may include global selection switch transistors GSEL. One end of each of the global selection switch transistors GSEL may be connected to the first output node N1, and the other end of each of the global selection switch transistors GSEL may be connected to the second node N2. The two global selection switch transistors GSEL included in the global selection switch circuit 1311b may operate based on the same control signal. For example, the two global selection switch transistors GSEL included in the global selection switch circuit 1311b may operate in response to the same control signal. According to an embodiment, the global select switch transistors GSEL may be turned on or off based on a global selection control signal. In an example case in which the global selection switch transistors GSEL are turned on, the first output nodes N1 may be connected to the second node N2, and outputs of the first photoelectric conversion regions 111b_1 and 111b_2) may be read out during a global shutter operation.

The global shutter operation circuit 1312b may include a precharge transistor PCX and a precharge select transistor PSEL2. A first terminal of the precharge transistor PCX may be connected to the second node N2, and a second terminal of the precharge transistor PCX may be connected to the precharge select transistor PSEL2. The second node N2 may be connected to a point at which the global shutter operation circuit 1312b is connected to the global selection switch circuit 1311b. The precharge transistor PCX may precharge the second node N2 based on a precharge control signal PC received from the row driver 120 in FIG. 1. For example, the precharge transistor PCX may precharge the second node N2 in response to the precharge control signal PC.

A first terminal of the precharge select transistor PSEL2 may be connected to the precharge transistor PCX, and a ground voltage may be applied to a second terminal of the precharge select transistor PSEL2. The precharge select transistor PSEL2 may be turned on or off based on a precharge selection control signal received from the row driver 120 and may reset the second node N2. For example, the precharge select transistor PSEL2 may be turned on or off in response to the precharge selection control signal. The precharge transistor PCX may be connected in series to the precharge select transistor PSEL2. According to an embodiment, the precharge transistor PCX and the precharge select transistor PSEL2 may be a precharge circuit.

The global shutter operation circuit 1312b may include an additional precharge select transistor PSEL1. The additional precharge select transistor PSEL1 may be connected between the second node N2 and a third node N3. The additional precharge select transistor PSEL1 may be turned on or off based on an additional precharge selection control signal received from the row driver 120 and may reset the third node N3. For example, the additional precharge select transistor PSEL1 may be turned on or off based on the additional precharge selection control signal. A first output node may include a parasitic capacitor CLP.

The global shutter operation circuit 1312b may include a first sampling transistor SMP1. A first terminal of the first sampling transistor SMP1 may be connected to the third node N3, and a second terminal of the first sampling transistor SMP1 may be connected to a first capacitor C1. The first sampling transistor SMP1 may be turned on or off based on a first sampling control signal received from the row driver 120, and the first capacitor C1 and the third node N3 may be connected to each other through the first sampling transistor SMP1. For example, the first sampling transistor SMP1 may be turned on or off in response to the first sampling control signal.

A pixel voltage VPIX may be applied to a first terminal of the first capacitor C1, and a second terminal of the first capacitor C1 may be connected to the first sampling transistor SMP1. Charges may be accumulated in the first capacitor C1 according to a switching operation of the first sampling transistor SMP1. For example, charges may be accumulated in the first capacitor C1 according to a reset operation in which the floating diffusion node FD is reset.

The global shutter operation circuit 1312b may include a capacitance adjustment circuit 1313b. The capacitance adjustment circuit 1313b may include second sampling transistors SMP2-1, SMP2-2, and SMP2-3 and third sampling transistors SMP3-1, SMP3-2, and SMP3-3. However, the disclosure is not limited thereto, and as such, the number of the second sampling transistors and the number of the third sampling transistors may be different than three. The second sampling transistors SMP2-1, SMP2-2, and SMP2-3 may be connected in parallel to the third sampling transistors SMP3-1, SMP3-2, and SMP3-3. A first terminal of the second sampling transistor SMP2-1 may be connected to the third node N3. The pixel voltage VPIX may be applied to a second terminal of the second sampling transistor SMP2-3. The second sampling transistors SMP2-1, SMP2-2, and SMP2-3 may be connected in series to each other, and each of the second sampling transistors SMP2-1, SMP2-2, and SMP2-3 may be turned on or off based on a second sampling control signal received from the row driver 120. For example, each of the second sampling transistors SMP2-1, SMP2-2, and SMP2-3 may be turned on or off in response to the second sampling control signal. A conversion gain may be adjusted depending on the number of transistors that are turned on among the plurality of transistors included in the second sampling transistors SMP2-1, SMP2-2, and SMP2-3. According to an embodiment, the second sampling transistors SMP2-1, SMP2-2, and SMP2-3 may control the conversion gain according to accumulate charges according to a photocharge accumulation operation in which the photocharges generated by the photodiode PD are accumulated in the floating diffusion node FD.

A first terminal of the third sampling transistor SMP3-1 may be connected to the third node N3. The pixel voltage VPIX may be applied to a second terminal of the third sampling transistor SMP3-3 The third sampling transistors SMP3-1, SMP3-2, and SMP3-3 may be connected in series to each other, and each of the third sampling transistors SMP3-1, SMP3-2, and SMP3-3 may be turned on or off based on a third sampling control signal received from the row driver 120. For example, each of the third sampling transistors SMP3-1, SMP3-2, and SMP3-3 may be turned on or off in response to the third sampling control signal. The conversion gain may be adjusted depending on the number of transistors that are turned on among the plurality of transistors included in the third sampling transistors SMP3-1, SMP3-2, and SMP3-3. According to an embodiment, the third sampling transistors SMP3-1, SMP3-2, and SMP3-3 may adjust a conversion gain of charges according to an autofocus (AF) operation of the first pixel PX1b.

According to an embodiment, the global shutter operation circuit 1312b may further include a capacitor that stores charges according to an accumulation operation of photocharges accumulated in the floating diffusion node FD, and another capacitor that stores charges according to an AF operation of the first pixel PX1b.

Referring to FIG. 8, by controlling a control signal applied to transistors included in the capacitance adjustment circuit 1313b, whether to turn on or off the transistors included in the capacitance adjustment circuit 1313b may be determined, and accordingly, a conversion gain in a global shutter circuit operation mode may be controlled. According to an embodiment of the disclosure, iDCG in one frame may be controlled by further including a plurality of transistors for controlling the conversion gain of the global shutter circuit 131b. The iDCG may refer to technology that may increase HDR performance with a single exposure by adjusting capacitance differently in various environments to synthesize images.

Although FIG. 8 illustrates that the number of second sampling transistors SMP2-1, SMP2-2, and SMP2-3 is 3 and the number of third sampling transistors SMP3-1, SMP3-2, and SMP3-3 is 3, the disclosure is not limited thereto, and the number of second sampling transistors SMP2-1, SMP2-2, and SMP2-3 and the number of third sampling transistors SMP3-1, SMP3-2, and SMP3-3 may each be 2 or more. Because the capacitance adjustment circuit 1313b according to an embodiment of the disclosure may extend to a lower region of the region in which the second pixel PX2b is arranged, a free space may be provided, and accordingly, the second sampling transistors SMP2-1, SMP2-2, and SMP2-3 and the third sampling transistors SMP3-1, SMP3-2, and SMP3-3 may each be four or more transistors and be arranged in series. Referring to FIG. 8, a dashed line between the first photoelectric conversion regions 111b_1 and 111b_2 and the first rolling shutter circuits 121b_1 and 121b_2 of the first pixel PX1b and the global shutter circuit 131b may mean that a chip in which the first photoelectric conversion regions 111b_1 and 111b_2 and the first rolling shutter circuits 121b_1 and 121b_2 of the first pixel PX1b are provided is different from a chip in which the global shutter circuit 131b is provided.

The global shutter operation circuit 1312b may include a global source follower transistor SF2 and a global select transistor SEL2. The pixel voltage VPIX may be applied to a first terminal of the global source follower transistor SF2, and a second terminal of the global source follower transistor SF2 may be connected to the global select transistor SEL2. The global source follower transistor SF2 may amplify and output a potential change in the third node N3.

A first terminal of the global select transistor SEL2 may be connected to the global source follower transistor SF2, and a second terminal of the global select transistor SEL2 may be connected to a second output line Vout_GS. The global select transistor SEL2 may be turned on or off based on a selection control signal received from the row driver 120. For example, the global select transistor SEL2 may be turned on or off in response to the selection control signal. In an example case in which the global select transistor SEL2 is turned on, a reset signal corresponding to a reset operation may be output to the second output line Vout_GS, or an image signal corresponding to a charge accumulation operation may be output to the second output line Vout_GS, or an AF signal corresponding to an AF operation may be output to the second output line Vout_GS.

The global source follower transistor SF2 and the global select transistor SEL2 may output a pixel signal according to a change in potential in the third node N3 to the second output line Vout_GS.

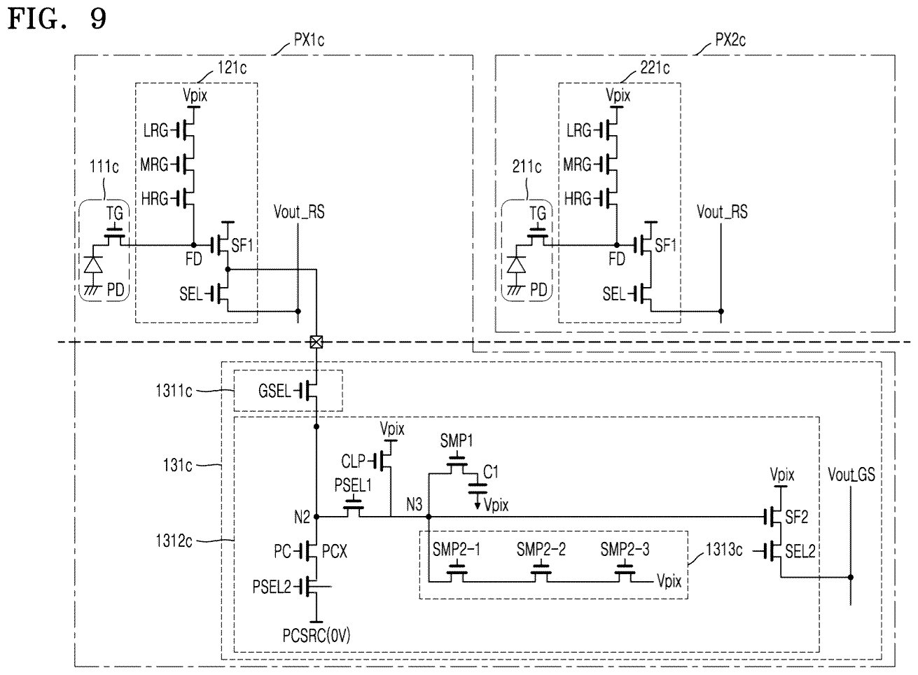

FIG. 9 illustrates a circuit diagram of a first pixel and a second pixel according to an embodiment.

Referring to FIG. 9, circuit diagrams of a first pixel PX1c and a second pixel PX2c are illustrated. The first pixel PX1c may include a first photoelectric conversion region 111c, a first rolling shutter circuit 121c, and a global shutter circuit 131c. The second pixel PX2c may include a second photoelectric conversion region 211c and a second rolling shutter circuit 221c. A difference from FIG. 8 is that the first pixel PX1c may have a 1PD structure including only the first photoelectric conversion region 111c. The second pixel PX2c may also have the 1PD structure. The other structures correspond to the structures described with reference to FIG. 8, and accordingly, descriptions thereof are omitted below.

The global shutter circuit 131c of FIG. 9 may include a global selection switch circuit 1311c and a global shutter operation circuit 1312c. Because the first photoelectric conversion region 111c of FIG. 9 has a 1PD structure, the global selection switch circuit 1311c may include one global selection switch transistor GSEL. Also, the capacitance adjustment circuit 1313c included in the global shutter operation circuit 1312c may include only the second sampling transistors SMP2-1, SMP2-2, and SMP2-3. Because processing of an AF operation is not required in the 1PD structure, the third sampling transistor SMP3-1, SMP3-2, and SMP3-3 illustrated in FIG. 8 may not be included in the capacitance adjustment circuit 1313c. The other operation methods and components of the global shutter circuit 131c of FIG. 9 are the same as the operation method and components of the global shutter circuit 131b of FIG. 8, and accordingly, descriptions thereof are omitted below.

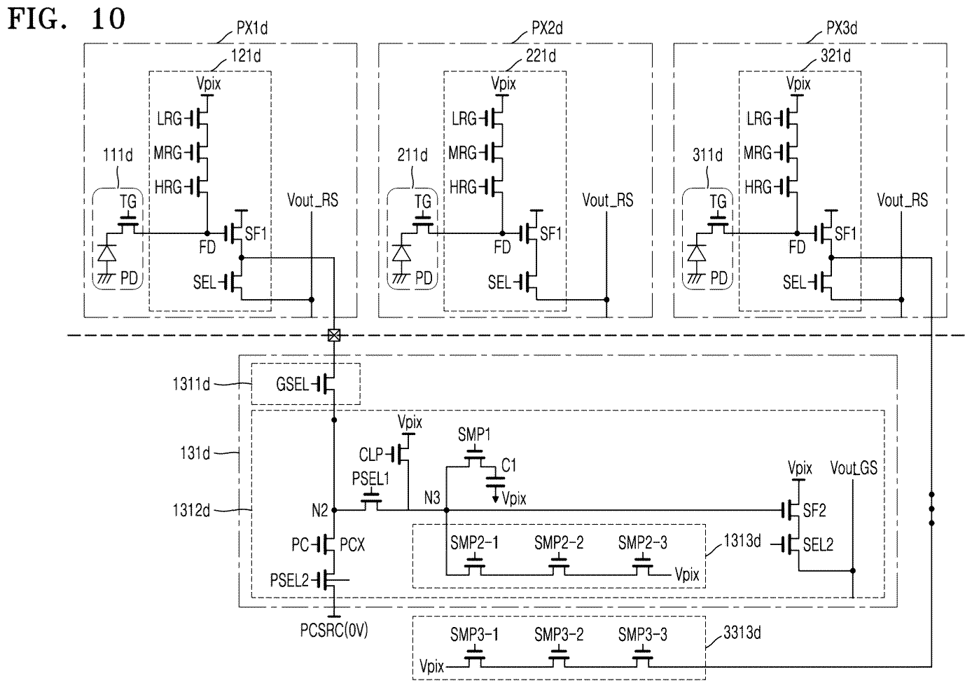

FIG. 10 illustrates a circuit diagram of a first pixel and a second pixel according to an embodiment.

Referring to FIG. 10, circuits of a first pixel PX1d, a second pixel PX2d, and a third pixel PX3d are illustrated. Components included in the first pixel PX1d and the second pixel PX2d are the same as the components of the first pixel PX1c and the second pixel PX2c illustrated in FIG. 9, and accordingly, descriptions thereof are omitted below.

Referring to FIG. 10, the third pixel PX3d is illustrated. The third pixel PX3d may have the same circuit structure as the first pixel PX1d adjacent to the second pixel PX2d. According to an embodiment, the third pixel PX3d has the same circuit structure as the first pixel PX1d, and accordingly, the third pixel PX3d may include a global shutter circuit, and the global shutter circuit may include a capacitance adjustment circuit 3313d. Referring to FIG. 10, not only the global shutter circuit 131d of the first pixel PX1d but also the capacitance adjustment circuit 3313d included in the global shutter circuit of the third pixel PX3d may be arranged in a lower region of an upper chip in which the second pixel PX2d is provided. The capacitance adjustment circuit 1313d of the first pixel PX1d adjacent to the left of the second pixel PX2d may extend to the right, and the capacitance adjustment circuit 3313d of the third pixel PX3d adjacent to the right of the second pixel PX2d may extend to the left. That is, the first and third pixels PX1d and PX3d respectively including global shutter circuits adjacent to the second pixel PX2d in both directions may obtain a conversion gain in a global shutter operation by arranging the capacitance adjustment circuits 1313d and 3313d in a lower region of the second pixel PX2d, and accordingly, a space may be used efficiently.

According to an embodiment, the embodiment of FIG. 10 may provide a nona pattern or a pixel arrangement when a high-resolution pixel output is required.

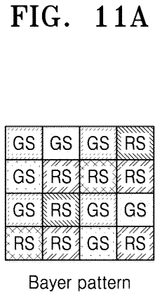

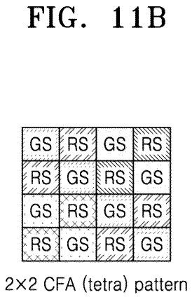

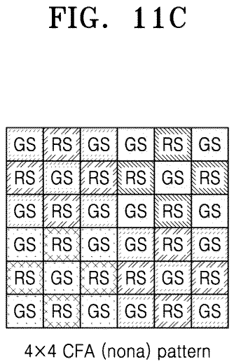

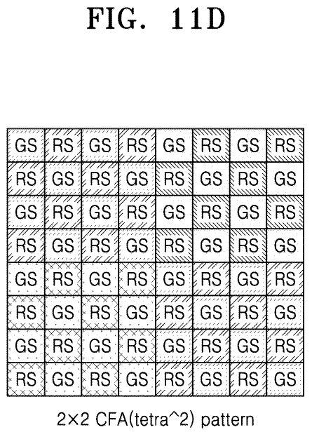

FIGS. 11A to 11D illustrate pixel outputs from an image sensor according to an embodiment of the disclosure. In FIGS. 11A to 11D, regions marked as GS may indicate pixels respectively including global shutter circuits, and regions marked as RS may indicate pixels respectively including rolling shutter circuits. According to an embodiment, the regions marked as GS may be first pixels, and the regions marked as RS may be second pixels.

FIG. 11A illustrates a pixel output of a color filter array having a Bayer pattern. Referring to FIG. 11A, an example is illustrated in which a Bayer pattern is formed in units of four 2×2 pixels, and pixels respectively including rolling shutter circuits and pixels respectively including global shutter circuits are mixed and output in one Bayer pattern.

FIG. 11B illustrates a pixel output of a color filter array having a Bayer pattern in units of 2×2 subpixels. Referring to FIG. 11B, an example is illustrated in which one color is configured in the Bayer pattern in units of 4 pixels, and pixels respectively including rolling shutter circuits and pixels respectively including global shutter circuits are mixed and output in 2×2 subpixels.

FIG. 11C illustrates a pixel output of a color filter array having a Bayer pattern in units of 3×3 subpixels. Referring to FIG. 11C, an example is illustrated in which one color is configured in the Bayer pattern in units of 9 pixels, and pixels respectively including rolling shutter circuits and pixels respectively including global shutter circuits are mixed and output in a 3×3 subpixel.

FIG. 11D illustrates a pixel output of a color filter array having a Bayer pattern in units of 4×4 subpixels. Referring to FIG. 11D, an example is illustrated in which one color is configured in the Bayer pattern in units of 16 pixels, and pixels respectively including rolling shutter circuits and pixels respectively including global shutter circuits are mixed and output in a 4×4 subpixel.

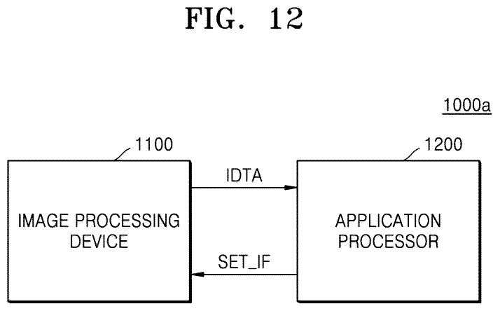

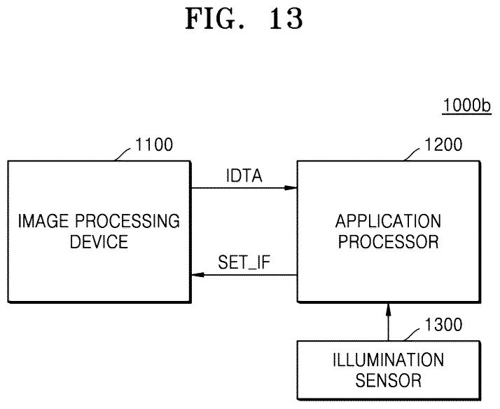

FIGS. 12 and 13 are block diagrams schematically illustrating electronic devices including image sensors, according to one or more embodiments.

Referring to FIGS. 12 and 13, electronic devices 1000a and 1000b may each include an image processing device 1100 and an application processor (AP) 1200.

The application processor 1200 may transmit control signals for controlling an operation of the image processing device 1100 to the image processing device 1000. The control signals may include setting information SET_IF for setting a mode of the image processing device 1100. For example, the setting information SET_IF for setting the mode of the image processing device 1100 may include, but is not limited to, setting an operation mode, setting a shuttering mode, or setting a conversion gain mode. Transmission of the control signals may be performed based on an interface based on, for example, an inter-integrated circuit (I2C). The control signals may further include configuration data of the image processing device 1100, such as a lens shading correction value, a crosstalk coefficient, an analog gain, a digital gain, and a frame rate setting value. According to an embodiment, the setting information SET_IF may be information on imaging conditions, such as flash information, integration time information, auto exposure (AE) information, and motion information.

The image processing device 1100 may generate image data IDTA by imaging a target object based on received control signals. The image data IDTA may include still images and moving images. The image processing device 1100 may perform signal processing, such as image quality compensation, binning, and downsizing, on the image data IDTA, and the image quality compensation may include signal processing, such as black level compensation, lens shading compensation, crosstalk compensation, and bad pixel correction. However, the disclosure is not limited thereto, and as such, the image processing device 1100 may be configured to perform other operations.

The image processing device 1100 may include an image sensor and an image signal processor. The image sensor described above may be applied as an image sensor included in the image processing device 1000 illustrated in FIGS. 12 and 13. A pixel array (110 of FIG. 1) of the image sensor included in the image processing device 1100 may include a first pixel operating in a global shutter mode or a rolling shutter mode and a second pixel operating in the rolling shutter mode. Also, the pixel array 110 may operate in a high conversion gain mode, a low conversion gain mode, or a dual conversion gain mode. A processing mode of an output of the pixel array 110 may be determined based on the setting information SET_IF. This is described below with reference to FIG. 14.

The image processing device 1100 may transmit the image data IDTA or signal-processed image data IDTA to the application processor 1200. Transmission of the image data IDTA may be performed through, for example, a camera serial interface (CSI) based on mobile industry processor interface (MIPI) but the disclosure is not limited thereto.

The application processor 1200 may perform image processing, such as bad pixel correction, 3A adjustment (auto-focus correction, auto-white balance, and auto-exposure), noise reduction, sharpening, gamma control, remosaic, demosaic, and resolution scaling (video/preview) on the received image data IDTA.

Also, the application processor 1200 may generate an image with a high dynamic range by performing HDR processing on a plurality of pieces of image data IDTA with different luminance.

Referring to FIG. 13, the electronic device 1000b may further include an illumination sensor 1300. The illuminance sensor 1300 may sense ambient illuminance of the electronic device 1000b and transmit information on the ambient illuminance to the application processor 1200.

The application processor 1200 may determine an operation mode, a shuttering mode, or a conversion gain mode of the image processing device 1100 based on illuminance information. The application processor 1200 may change the setting information SET_IF applied to the image processing device 1100 by reflecting the illuminance information. In an example case in which illuminance is less than a reference value, the application processor 1200 may cause the image processing device 1100 to operate in a global shutter mode, and in an example case in which the illuminance is greater than or equal to the reference value, the application processor 1200 may change the setting information SET_IF such that the image processing device 1100 operates in a rolling shutter mode.

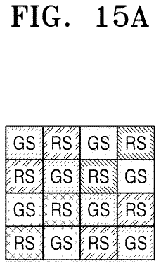

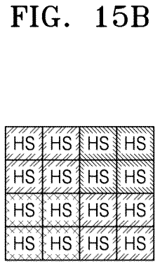

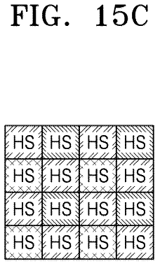

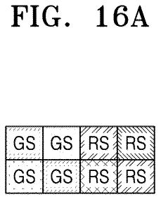

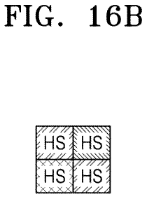

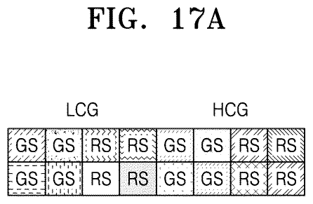

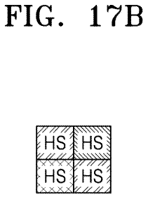

FIG. 14 is a diagram illustrating an image processing device according to an embodiment. FIGS. 15A to 15C are diagrams illustrating an output in a first operation mode according to an embodiment, and FIGS. 16A and 16B are diagrams illustrating an output in a second operation mode according to an embodiment, and FIGS. 17A and 17B are diagrams illustrating an output in a third operation mode according to an embodiment.

In FIGS. 15A, 15B, 15C, 16A, 16B, 17A, and 17B, regions marked as GS may indicate pixels respectively including global shutter circuits, and regions marked as RS may indicate pixels respectively including rolling shutter circuits. The regions marked HS may indicate hybrid pixel data. According to an embodiment, the regions marked GS may each be a first pixel, and the regions marked RS may each be a second pixel.

Referring to FIG. 14, an image processing device including an image sensor 1100a and an image signal processor 1900 is illustrated.

According to an embodiment, first image data IDTA1 output from the image sensor 1100a may be image data resulting from including both a global shutter pixel and a rolling shutter pixel. The image signal processor 1900 may receive the first image data IDTA1 and setting information SET_IF and generate second image data IDTA2. The second image data IDTA2 may be generated by signal-processing the first image data IDTA1 in any one of a first operation mode, a second operation mode, and a third operation mode, based on the setting information SET_IF.

The setting information SET_IF may be received by the application processor 1200 illustrated in FIGS. 12 and 13. However, the disclosure is not limited thereto, and as such, the setting information SET_IF information may be received (or retrieved) in another manner. For example, the setting information SET_IF information may be received by firmware. According to an embodiment, an output of the second image data IDTA2 may be changed by receiving information, such as motion information, an analog gain, and flash. In an example case in which the image signal processor 1900 is turned off, rolling shutter data and global shutter data may be output simultaneously.

In the first operation mode, data of all pixels included in the first image data IDTA1 may be output as hybrid shutter data or as global shutter data. According to an embodiment, in the first operation mode, pixels including the rolling shutter data and global shutter data included in the first image data IDTA1 may predict and output the hybrid shutter data or global shutter data. In this process, data may be output as a result of conversion to a Bayer pattern. According to an embodiment, in the first operation mode, only the advantages of rolling shutter and global shutter may be used in flash, low light conditions, or so on. According to an embodiment, in the first operation mode, during a high-speed frame operation, noise may be reduced compared to operating with only a global shutter, and flash and a Jello phenomenon may be reduced compared to operating with only a rolling shutter. In this operation mode, a full resolution output of global shutter, rolling shutter, or hybrid shutter may be performed.

FIG. 15A illustrates a pixel output of a Bayer pattern applied in tetra format according to an embodiment. An example is illustrated in which pixels corresponding to one color of the Bayer pattern and including global shutter pixels and rolling shutter pixels mixed together are arranged. According to an embodiment, hybrid shutter data may be generated on a Bayer pattern as illustrated in FIG. 15B through a pixel output value according to FIG. 15A, and rearrangement may be performed in a Bayer pattern that does not include subpixels as illustrated in FIG. 15C.

In the second operation mode, hybrid shutter pixel data may be output by combining pixels of the same color and the same shutter pixel among the pieces of pixel data included in the first image data IDTA1 and then by performing signal processing of the pixels. In this process, the resolution may be lowered. According to an embodiment, in the second operation mode, rolling shutter data and global shutter data may be simultaneously output for every frame, or hybrid shutter data may be output. According to another embodiment, in the second operation mode, pixel data included in the first image data IDTA1 may be output only with a global shutter or only with a rolling shutter.

According to an embodiment, FIG. 16A may be pixel data obtained by combining the global shutter data and the rolling shutter data for each color and for each shutter. According to an embodiment, FIG. 16B illustrates hybrid data generated based on the pixel data illustrated in FIG. 16A.

In the third operation mode, among the pieces of pixel data included in the first image data IDTA1, data having different conversion gains may be mixed and processed. In a third operation mode according to an embodiment, by using rolling shutter data and global shutter data with a low conversion gains, and rolling shutter data and global shutter data with a high conversion gain, motion may be greatly reduced, and a dynamic range may be greatly increased.

FIG. 17A may be pixel data including global shutter data and rolling shutter data output with a low conversion gain (LCG) and global shutter data and rolling shutter data output with a high conversion gain (HCG). Based thereon, final hybrid shutter data illustrated in FIG. 17B may be generated. According to an embodiment, FIG. 17B illustrates final hybrid shutter data generated based on the pixel data illustrated in FIG. 17A

That is, by selecting one of the first operation mode, the second operation mode, and the third operation mode based on the setting information SET_IF, image data suitable for the surrounding environment may be synthesized and output. According to an embodiment, the image signal processor 1900 may acquire night images by using flash. The image signal processor 1900 may acquire a global shutter image that is robust against noise. The image signal processor 1900 may operate at a frame rate that is twice the current frame rate during a hybrid shutter output operation. The image signal processor 1900 may also be used for a high-resolution and micro-process. The image signal processor 1900 may acquire a dynamic range of HDR in a global shutter operation, and thus may acquire a dynamic range in a video mode and so on.

According to an embodiment, based on the setting information SET_IF being information on a motion, the image signal processor 1900 may detect whether a motion occurs by using an information difference between a global shutter pixel and a rolling shutter pixel, and may output hybrid shutter data based on whether a motion occurs.

According to an embodiment, based on the setting information SET_IF being information on noise, the image signal processor 1900 may selectively output rolling shutter data and global shutter data depending on noise.

According to an embodiment, based on the setting information SET_IF being information on HDR, the image signal processor 1900 may output hybrid shutter data by combining low conversion gain data with high conversion gain data. Also, HDR compositing may be performed after hybrid shutter data for each conversion gain is generated. According to an embodiment of the disclosure, a dynamic range may be additionally obtained compared to performing HDR synthesis only with a global shutter.

According to an embodiment, based on the setting information SET_IF being applied, the global shutter may be mainly output when a motion occurs, and the rolling shutter may be mainly output when noise occurs. The hybrid shutter data that is finally output may be output according to an equation below.

HS=w1*GS+w2*RS

In the above equation, HS may be hybrid shutter data, w1 may be a weight of a global shutter mode, w2 may be a weight of a rolling shutter mode, GS may be global shutter output data, and RS may be rolling shutter output data. According to an embodiment, in an example case in which a motion occurs, w1 may be increased and w2 may be decreased, and in an example case in which noise occurs, w2 may be increased and w1 may be decreased.

According to an embodiment of the disclosure, hybrid global shutter data may be acquired in one frame, and a frame rate of a video mode may be increased. According to an embodiment of the disclosure, a dynamic range may be obtained during an iDCG operation, and the iDCG operation in a global shutter may be performed.

According to an embodiment of the disclosure, the image signal processor 1900 may simultaneously output or combine global shutter image data and rolling shutter image data within the same frame by using a pixel array including one or more global shutter pixels and one or more rolling shutter pixels.

The image signal processor 1900 may output hybrid data by combining data values of a global shutter and a rolling shutter adjacent to each other. The image signal processor 1900 may output the global shutter data and rolling shutter data with different conversion gains. The image signal processor may output rolling shutter data and global shutter data of some pixels or all images, or hybrid shutter data obtained by combining the rolling shutter data and global shutter data according to control signal information, such as flash, low light, a motion, and so on.

The image signal processor 1900 according to an embodiment of the disclosure may operate in various output modes by using a multi-array color filter array. Also, an arrangement according to CFA may be changed as needed, and high-pixel and fine pixels may be provided.

According to a comparative example, global shutters are provided in all pixels, and accordingly, an iDCG HDR of a global shutter is not provided due to a lack of space for forming capacitors, and it is difficult to develop fine pixels and a high-resolution global shutter. According to the comparative example, in one frame, only a shutter operating in one method may be output, and accordingly, only global shutter data or only rolling shutter data may be output. Therefore, there may be problems that may still occur in each shutter, such as noise problems of a global shutter, a Jello phenomenon of a rolling shutter, and flash timing. Also, because two frames are required to operate a hybrid shutter, there is a problem of artifact occurring due to motion differences between frames.

According to an embodiment of the disclosure, high resolution may be obtained by arranging global shutter pixels and rolling shutter pixels in an image sensor and changing a circuit to obtain a space for placing capacitors. Also, low conversion gain and high conversion gain may be obtained from the global shutter pixel with the same pixel data, and accordingly, an iDCG HDR of a global shutter may be obtained, and a dynamic range of the iDCG HDR may be increased. Also, hybrid shutter data may be generated with one frame, and accordingly, motion artifact may not occur between frames.

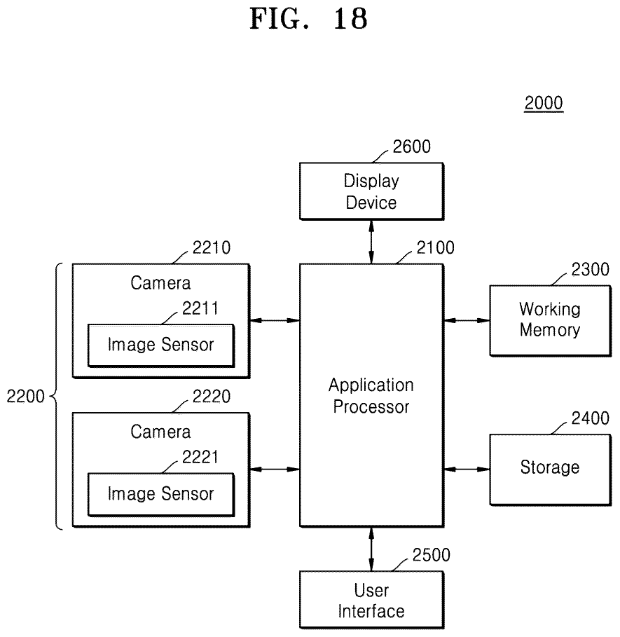

FIG. 18 is a block diagram illustrating an electronic device including an image sensor, according to an embodiment. An electronic device 2000 illustrated in FIG. 18 may be a portable terminal.

Referring to FIG. 18, the electronic device 2000 may include an application processor 2100, a camera module 2200, a display device 2600, a working memory 2300, a storage 2400, and a user interface 2500. The electronic device 2000 may further include other general-purpose components, such as a communication module, a sensor module, and so on.

The application processor 2100 may control all operations of the electronic device 2000 and may be implemented as a system-on-chip (SoC) that executes an application program, an operating system, and so on. The application processor 2100 may provide image data received from the camera module 2200 to the display device 2600 or store the image data in the storage 2400. In the embodiment, the application processor 2100 may include an image processing circuit and perform image processing of the image data received from the camera module 2200, such as image quality control, a data format change, and HDR processing.

The camera module 2200 may include a plurality of cameras, for example, a first camera 2210 and a second camera 2220. The first camera 2210 and the second camera 2210 may respectively include an image sensor 2211 and an image sensor 2221. At least one of the first image sensor 2211 and the second image sensor 2221 may be implemented by the image sensor described above. At least one of the first image sensor 2211 and the second image sensor 2221 may be selectively shuttered according to a rolling shutter method (a rolling shutter mode) or a global shutter method (a global shutter mode), or may be shuttered by using a hybrid shutter method.

The working memory 2300 may include a volatile memory, such as DRAM or SRAM, or non-volatile resistive memory, such as ferroelectric RAM (FeRAM), resistive RAM (RRAM), or phase change RAM (PRAM). The working memory 2300 may store programs and/or data processed or executed by the application processor 2100.

The storage 2400 may include a non-volatile memory device, such as NAND flash or resistive memory, and may be provided as a memory card, such as a multi-media card (MMC), an embedded MMC (eMMC), a secure digital (SD) card, or micro SD card. The storage 2400 may store image data provided by the camera module 2200.

The user interface 2500 may include various devices that may receive user inputs, such as a keyboard, a curtain key panel, a touch panel, a fingerprint sensor, and a microphone. The user interface 2500 may receive a user input and provide a signal corresponding to the received user input to the application processor 2100.

In the disclosure, embodiments are described by using certain terms, but this is only used for the purpose of describing the inventive concept and is not used to limit the meaning or scope of the inventive concept described in claims. Therefore, those skilled in the art will understand that various modifications and other equivalent embodiments may be derived therefrom. Therefore, the true technical protection scope of the inventive concept should be determined by the technical idea of the attached claims.

While the inventive concept has been particularly shown and described with reference to embodiments thereof, it will be understood that various changes in form and details may be made therein without departing from the spirit and scope of the following claims.

What is claimed is:

1. An image sensor comprising:
a pixel array comprising a plurality of pixels,
wherein the plurality of pixels comprise:
a first pixel comprising a first circuit configured to operate in a first shutter mode and a second circuit configured to operate in a second shutter mode; and
a second pixel comprising a third circuit configured to operate only in the first shutter mode, among the first shutter mode and the second shutter mode, and
wherein the first pixel is adjacent to the second pixel.

2. The image sensor of claim 1, further comprising a color filter array arranged over the pixel array,
wherein the color filter array comprises a Bayer pattern.

3. The image sensor of claim 1, wherein the first shutter mode comprises a rolling shutter mode, and
wherein the second shutter mode comprises a global shutter mode.

4. The image sensor of claim 1, wherein the image sensor comprises a first chip and a second chip arranged in stacked structure, and
wherein the first circuit and the second circuit are provided in different chips of the image sensor.

5. The image sensor of claim 4, wherein the first circuit is provided in the first chip,
wherein the second circuit is provided in the second chip,
wherein the second chip is arranged under the first chip, and
wherein the second circuit extends to a lower region in which the second pixel is arranged.

6. The image sensor of claim 1, wherein the second circuit comprises:
a global selection switch circuit comprising at least one first transistor; and
a global shutter operation circuit connected to one end of the global selection switch circuit and configured to read out, based on a global shutter technique, photocharges accumulated in a floating diffusion node of in the first circuit, and
wherein the global shutter operation circuit comprises a capacitance adjustment circuit configured to adjust a conversion gain.

7. The image sensor of claim 6, wherein the capacitance adjustment circuit comprises two or more second transistors connected in series.

8. The image sensor of claim 6, wherein a number of the two or more second transistors in the capacitance adjustment circuit corresponds to a number of one or more third transistors in the first circuit, the one or more third transistors configured to adjust a conversion gain.

9. An image processing device comprising:
an image sensor comprising a plurality of pixels and a color filter array on the plurality of pixels; and
an image signal processor configured to process and output data from the image sensor,
wherein the plurality of pixels comprise:
a first pixel comprising a first circuit configured to operate in a first shutter mode and a second circuit configured to operate in a second shutter mode, and
a second pixel comprising a third circuit configured to operate only in the first shutter mode, among the first shutter mode and the second shutter mode,
wherein the first pixel is adjacent to the second pixel, and
wherein the image signal processor is configured to:
receive setting information comprising information on one of an image and an imaging condition, and
determine a processing mode of the data output from the image sensor based on the setting information.

10. The image processing device of claim 9, wherein the setting information comprises at least one of flash information, exposure time information, motion information, and auto exposure (AE) information.

11. The image processing device of claim 9, wherein the first shutter mode comprises a rolling shutter mode, and
wherein the second shutter mode comprises a global shutter mode.

12. The image processing device of claim 11, wherein the image sensor comprises a first chip and a second chip arranged in stacked structure,
wherein the first circuit and the second circuit are provided in different chips of the image sensor.

13. The image processing device of claim 12, wherein the first circuit is provided in the first chip,
wherein the second circuit is provided in the second chip,
wherein the second chip is arranged under the first chip, and
wherein the second circuit extends to a lower region in which the second pixel is arranged.

14. The image processing device of claim 13, wherein the image signal processor is configured to operate in an operation mode in which output data of the first pixel and output data of the second pixel are combined with each other and output.

15. The image processing device of claim 13, wherein the image signal processor is configured to operate in an operation mode in which the first pixel and the second pixel having a same color and/or a same shutter mode are mixed and output.

16. The image processing device of claim 13, wherein the image signal processor is configured to operate in an operation mode in which output data having different conversion gain values are mixed and output.

17. The image processing device of claim 13, wherein the image signal processor is configured to determine respective weights of output data of the first pixel and output data of the second pixel based on the setting information.

18. An image sensor comprising:
a first chip comprising a plurality of rolling shutter circuit regions configured to readout a plurality of pixels based on a rolling shutter technique; and
a second chip comprises a plurality of global shutter circuit regions configured to readout out the plurality of pixels based on a global shutter technique,
wherein a number of the plurality of global shutter circuit regions is less in a number of the plurality of rolling shutter circuit regions.

19. The image sensor of claim 18, wherein the plurality of global shutter circuit regions are electrically connected to at least one of the plurality of rolling shutter circuit regions arranged in the first chip, and
wherein the plurality of global shutter circuit regions extend to lower regions of the plurality of rolling shutter circuit regions that are not electrically connected to the plurality of global shutter circuit regions.

20. The image sensor of claim 18, wherein each of the plurality of global shutter circuit regions comprises:
a global selection switch circuit comprising at least one first transistor; and
a global shutter operation circuit connected to one end of the global selection switch circuit and configured to read out photocharges accumulated in a floating diffusion node in the plurality of rolling shutter circuit regions based on a global shutter technique,
wherein the global shutter operation circuit comprises a capacitance adjustment circuit configured to adjust a dual conversion gain, and
wherein the capacitance adjustment circuit comprises at least two second transistors connected in series.
